(19) United States
(12) Patent Application Publication
(10) Pub. No.: US 2021/0134124 A1
(43) Pub. Date: May 6, 2021

(54) IN-STADIUM AND LOCATION-BASED USER INPUTS TO ADJUST IN-GAME BET PRICING AND PROBABILITIES

(71) Applicant: SCORETRADE INC., Greenbrae, CA (US)

(72) Inventor: Bhuvanesh SRINIVASAN, Greenbrae, CA (US)

(21) Appl. No.: 17/084,544

(22) Filed: Oct. 29, 2020

Related U.S. Application Data
(60) Provisional application No. 62/929,914, filed on Nov. 3, 2019.
(60) Provisional application No. 62/928,955, filed on Oct. 31, 2019.

(51) Int. Cl. G07F 17/32; H04W 4/021; G06Q 30/02; G06Q 50/34; G06N 7/00

(52) U.S. Cl. CPC G07F 17/3288; G07F 17/3244; G07F 17/3239; G06N 7/005; G06Q 30/0283; G06Q 50/34; H04W 4/021

(57) ABSTRACT

A system for operating a sports gaming event using a graphical interface of a computing device application, the system including a processor; and a memory coupled to the processor. The processor may be configured to select at least one betting scenario, determine a location of the at least one betting scenario, calculate an initial probability of the at least one betting scenario occurring, generate and display an initial price of the at least one betting scenario based on the initial probability, receive a response to the at least one betting scenario from at least one user from whom location has been determined, and calculate, based on user response and based on determining the location of the at least one user to be proximate to the location of the at least one betting scenario, whether the initial probability of the betting scenario occurring has changed.

### CROSS-REFERENCE TO RELATED APPLICATION(S)

This application claims priority to and the benefit of U.S. Provisional Patent Application No. 62/929,914 filed Nov. 3, 2019 and entitled “A SYSTEM OF USING IN-STADIUM AND LOCATION-BASED USER INPUTS TO ADJUST IN-GAME WAGER PROBABILITIES AND PRICING”, the entire content of which is incorporated herein by reference. This application further claims priority to and the benefit of U.S. Provisional Patent Application No. 62/928,955 filed Oct. 31, 2019 and entitled “A SYSTEM OF INTEGRATING AUTHENTICATED PAY TELEVISION STREAMS INTO MOBILE IN-GAME SPORTS GAMING APPLICATIONS”, the entire content of which is incorporated herein by reference.

### FIELD

One or more aspects of embodiments according to the present disclosure relate to systems and methods for using in-stadium and location-based user inputs to adjust in-game bet pricing and probabilities with respect to sports wagering.

### BACKGROUND

Online gaming has increased in popularity, especially after the Supreme Court of the United States ruling that individual states could legalize sports gambling within their states. Online gaming players (e.g., users) can engage in online sports gaming through an application operating on a computing device. The application may include, but is not limited to, social media platforms, media streaming platforms, mobile device applications. The computing devices may include, but are not limited to, personal computers, mobile smart phones, or tablets. Using the various mediums, players can place bets on the final outcome of sporting events. In addition, bets or selections can be made in the context of fantasy sports, where the user is attempting to select a roster or portfolio of players. Players can submit bets using real money or with fake money generated within the computing device application.

Recently, there has been more interest in live betting or in placing wagers relating to particular events that may occur during a game, but do not necessarily relate to an outcome for the entire game. Whereas traditional betting generally relates to the final outcome of the game or an outcome relating to statistics accumulated for an entire game, both fantasy sports and sports betting are increasingly based on engaging users with gaming propositions during the game. For example, the intervals for a person to place a wager and either win or lose such wager can be compressed to a single play, a single second or a single shot, or any other gaming metric that may not include an entire game or event. By their nature, sporting events, in particular, are complicated with countless structured, documentable, betable actions, but it will be appreciated that live betting could be applied to other events such as e-sports, video games, card games, and any other event in which there is interest for someone (e.g. a user) to wager that a particular event will occur and for someone (e.g., a gaming operator, a peer-to-peer marketplace, or a betting exchange) to accept such wager. In-game wagering and fantasy sports, particularly those related to in-game wagering, are expected to considerably grow the gross amount of wagering volume.

One significant issue for gaming operators and media companies is how to create the largest set of entertaining, engaging gaming propositions while ensuring that the bets are no longer open (i.e., no more wagers may be accepted) as soon as the outcome of the proposed wager is known. If the proposed wager is closed well before the outcome might or might not happen, the live nature of in-game betting is removed. If the proposed wager is closed too late, the user may be able to take advantage of the fact that they know the outcome while the proposed wager from a gaming operator is still being offered. The closer a proposed wager can stay open until the proposed wagering outcome occurs or does not occur, e.g., until or while a play or pitch or sequence can take place that will determine the outcome, the more entertaining and intriguing the bet will be.

However, one risk is that the betting scenario does not close or lock (i.e., the gaming system prevents any further wagering action on a particular betting scenario) before or immediately after the outcome can be determined, which may create an uneven playing field and may allow a user to have an advantage over the gaming operator or over other users. This conundrum then creates a scenario where a cautious gaming operator, betting exchange, or gaming ecosystem cannot create the most exciting, algorithmically driven propositions that stay open right up to the point of the play or even through the play, but closing immediately after. A gaming operator may assign a human to be deployed to close the proposed wager, but such human gaming operator may not have the capacity to monitor thousands or more open betting scenarios spanning hundreds of games and to be able to close out the proposed wager within a requisite amount of time after an outcome of the proposed wager has occurred, thus allowing users to profit from already-occurred events and potentially subjecting a gaming operator to large financial losses or other negative outcomes.

The above information disclosed in this Background section is only for enhancement of understanding of the background of the present disclosure, and therefore, it may contain information that does not form prior art.

### SUMMARY

In one embodiment, a system for operating a sports gaming event using a graphical interface of a computing device application is provided. The system includes a processor and a memory coupled to the processor, wherein the memory stores instructions that, when executed by the processor, cause the processor to: select at least one betting scenario from a betting scenario database, determine a location of the at least one betting scenario, calculate an initial probability of the at least one betting scenario occurring based on sports data and historical statistics, generate an initial price of the at least one betting scenario based on the initial probability, display the betting scenario and the initial price on the graphical interface, receive a response to the at least one betting scenario from at least one user, determine a location of the at least one user, compare the location of the at least one user to the location of at least one betting scenario, calculate, based on the response to the betting scenario from the at least one user and based on determining the location of the at least one user to be proximate to the location of the at least one betting scenario, whether the initial probability of the betting scenario occurring has changed, generate an updated price if the initial probability has changed, and display the updated price on the graphical interface.

In one embodiment, the instructions may further cause the processor to: receive updated sports data via a network, calculate an updated probability of the betting scenario being successful based on the updated sports data, generate a further updated price of the at least one betting scenario if the updated probability has changed, and display the further updated price on the graphical interface.

Further, in one embodiment, the processor may be configured to receive responses to the at least one betting scenario from a plurality of users and to determine the locations of each of the plurality of users, wherein, to calculate whether the initial probability of the betting scenario occurring has changed, the processor may be configured to place greater weight on a response from any user located proximate to the at least one betting scenario than a response from any user that is not located proximate to the at least one betting scenario.

Additionally, the processor may be configured to access a seating map area of the location of the at least one betting scenario and the processor may be configured to determine whether the location of the at least one user is within the seating map area. Further, wherein, when the location of the at least one user is within the seating map area, the processor is configured to evaluate whether the location of the at least one user provides reliable viewing access to an outcome of the at least one betting scenario.

In one embodiment, the response to the at least one betting scenario from at least one user may include buying at least one share of the at least one betting scenario; or selling at least one share of the at least one betting scenario. Further, wherein, when the location of the at least one user is determined to be proximate to the location of the at least one betting scenario and the response from the at least one user is to buy at least one share of the at least one betting scenario, the instructions cause the processor to increase the initial probability of the at least one betting scenario occurring.

Further, in one embodiment, when the location of the at least one user is determined to be proximate to the location of the at least one betting scenario and the response from the at least one user is to sell at least one share of the at least one betting scenario, the instructions may cause the processor to decrease the initial probability of the at least one betting scenario occurring.

In another embodiment, when the location of the at least one user is determined to be proximate to the location of the at least one betting scenario, the processor may be configured to predict, based on the response from the at least one user, that the at least one betting scenario has occurred, the instructions cause the processor to remove the at least one betting scenario from the graphical interface.

In one embodiment, a method is provided for operating a sports gaming event using a graphical interface of a computing device application, the method including receiving, by a processor, sports data via a network, generating, by the processor, a betting scenario based on the sports data, determining a location of the at least one betting scenario, calculating, by the processor, an initial probability of the betting scenario occurring based on the sports data, generating, by the processor, an initial price of the betting scenario based on the initial probability, wherein the initial price comprises a number between 1 and 99, displaying, by the processor, the betting scenario and the initial price on the graphical interface, receiving, by the processor, a response to the betting scenario from at least one user, determining, by the processor, a location of the at least one user, comparing, by the processor, the location of the at least one user to the location of the at least one betting scenario, calculating, by the processor, based on the response to the betting scenario from the at least one user and based on determining the location of the at least one user to be proximate to the location of the at least one betting scenario, whether the initial probability of the betting scenario occurring has changed, generating, by the processor, an updated price if the initial probability has changed, and displaying, by the processor, the updated price on the graphical interface.

In one embodiment, the method further includes receiving, by the processor, updated sports data via a network, calculating, by the processor, an updated probability of the betting scenario being successful based on the updated sports data, generating, by the processor, a further updated price of the at least one betting scenario if the updated probability has changed, and displaying, by the processor, the further updated price on the graphical interface.

In one embodiment, the processor may be configured to receive responses to the at least one betting scenario from a plurality of users and to determine the locations of each of the plurality of users and wherein, in calculating whether the initial probability of the betting scenario occurring has changed, the processor may place greater weight on a response from any user located proximate to the at least one betting scenario than a response from any user that is not located proximate to the at least one betting scenario .

In one embodiment, the method may further include accessing, by the processor, a seating map area of the location of the at least one betting scenario and determining, by the processor, whether the location of the at least one user is within the seating map area. Additionally, when the location of the at least one user is determined to be within the seating map area, the method may further include evaluating, by the processor, whether the location of the at least one user provides reliable viewing access to an outcome of the at least one betting scenario.

Additionally, in one embodiment, the response to the at least one betting scenario from at least one user includes buying at least one share of the at least one betting scenario or selling at least one share of the at least one betting scenario.

Further, when the location of the at least one user is determined to be proximate to the location of the at least one betting scenario and the response from the at least one user is to buy at least one share of the at least one betting scenario, the method may include calculating, by the processor, an increase in the initial probability of the at least one betting scenario occurring. Similarly, when the location of the at least one user is determined to be proximate to the location of the at least one betting scenario and the response from the at least one user is to sell at least one share of the at least one betting scenario, the method may include calculating, by the processor, a decrease in the initial probability of the at least one betting scenario occurring.

In one embodiment, when the location of the at least one user is determined to be proximate to the location of the at least one betting scenario, the method includes predicting, by the processor, based on the response from the at least one user, that the at least one betting scenario has occurred, and removing, by the processor, the at least one betting scenario from the graphical interface.

Further, in one embodiment, determining a location of the at least one user includes accessing, by the processor, a user's mobile device's geo-location data. Additionally, in one embodiment, calculating whether the initial probability of the betting scenario occurring has changed further includes comparing, by the processor, a response received from a first user determined to be proximate to the betting scenario against a response received from a first user determined to not be proximate to the betting scenario.

### BRIEF DESCRIPTION OF THE DRAWINGS

FIG. 1 illustrates a system block diagram for the operation of sports wagering using dynamic real-time pricing and trading according to an embodiment of the present disclosure.

FIG. 2 illustrates an interface for displaying sports wagering using dynamic real-time pricing and trading according to an embodiment of the present disclosure.

FIG. 3 illustrates a flow chart for the process of the gaming engine setting an initial price and adjusting the price based on various data and input considerations, including in-stadium gaming activity.

FIG. 4 illustrates a system block diagram for the operation of the gaming engine using dynamic real-time pricing and trading according to an embodiment of the present disclosure.

FIG. 5A illustrates a schematic view of a stadium and users' locations within the stadium.

FIG. 5B illustrates a flow chart for how the gaming engine may take into account in-stadium activity.

FIG. 6 illustrates a second interface for displaying sports wagering using dynamic real-time pricing and trading according to an embodiment of the present disclosure.

FIG. 7 illustrates a third interface for displaying sports wagering using dynamic real-time pricing and trading according to an embodiment of the present disclosure.

FIG. 8 illustrates an interface for displaying real-time in-game fantasy sports tournaments and leagues using dynamic real-time pricing and trading according to an embodiment of the present disclosure.

FIG. 9 illustrates an interface for a portfolio in a real-time in-game fantasy sports tournaments and leagues using dynamic real-time pricing and trading according to an embodiment of the present disclosure.

FIG. 10 illustrates an interface of a real-time in-game fantasy sports tournaments and leagues using dynamic real-time pricing that displays a community call according to an embodiment of the present disclosure.

FIG. 11 illustrates an interface of a real-time in-game fantasy sports tournaments and leagues using dynamic real-time pricing that displays a user video stream according to an embodiment of the present disclosure.

FIG. 12 illustrates an interface of a real-time in-game fantasy sports tournaments and leagues using dynamic real-time pricing that displays a live sporting event according to another embodiment of the present disclosure.

### DETAILED DESCRIPTION

The exemplary embodiments of the present invention disclosed herein are directed to a system and method for sports wagering using dynamic real-time pricing and trading, and particularly, using inputs from in-stadium or in-arena users among other inputs to set and adjust the pricing.

In general, an algorithmic gaming engine or Al or machine learning driven gaming engine is described that creates, monitors, and resolves betting scenarios in myriad permutations immediately or nearly immediately based on predictions the gaming engine makes about such outcomes. In one embodiment, the system described here is one where a betting scenario or a gaming proposition is allowed to stay open exactly to the start of the play or right through the play, but where the crowd-sourced actions of users at the stadium allows the gaming engine to determine with a high level of confidence that an outcome has occurred that materially impacts a gaming proposition and allows the gaming engine to take an action (such as closing the betting scenario, leaving the betting scenario open, or changing the price of the betting scenario).

Because the vast majority of users or bettors watch games on TV or other video feed or listen via radio rather than being at the stadium, this system may create a short-term advantage for users at the stadium, but allows gaming operators to offer the widest set of propositions and leave them open the longest, while not allowing gaming users watching on TV or elsewhere to have the same advantage over the gaming operator. In effect, the slight betting advantages presented to in-stadium bettors (i.e., the system leaving the betting scenarios open through a play) turns the in-stadium users into crowd-sourced entries of gaming data. For example, when betting scenarios are priced accurately and two sides of the betting scenario are offered, a confidence in the outcome of the betting scenario can be established when a repeated, consecutive set of signals comes in from multiple different users on one side of a bet, but not the other. In such case, the gaming engine can predict with a high degree of confidence that either the price may be adjusted or that the betting event should be locked or closed.

As used herein, a sports gaming event refers to an event wherein at least one user places at least one wager on at least one betting scenario (i.e., places a bet) displayed within an application and wherein the outcome of the wager is maintained by the application. As used herein, a sports gaming event can also refer to an event wherein at least one user sells a wager on at least one betting scenario to another user or to the “house” using an application. It will be appreciated that the term “sports” may refer to traditional sports such as soccer, baseball, and basketball, “esports” such as video games, as well as card games, board games, and any other competition on which betting scenarios could be generated. It will be further appreciated that “sports gaming event” and “gaming event” may be used interchangeably herein.

In embodiments, betting scenarios may be offered by a gaming engine that is associated with a gaming operator. As used herein, a gaming operator may be any person or entity that offers a value proposition on a betting scenario that allows user to wager, for real money, incentives, prizes, or other rewards, or no reward on the betting scenario. Examples of such gaming operators may include, but are not limited to betting exchanges, peer-to-peer markets, market makers, or the like.

According to various embodiments of the present disclosure, a betting scenario within a sports gaming event can be generated, selected, and/or displayed automatically by a gaming engine. In one embodiment, the gaming engine may be configured to select a betting scenario framework from a database of betting scenario frameworks and the gaming engine may be further configured to customize the betting scenario framework with specific players as dictated by the gaming event being administered by the gaming engine. Further, the gaming engine may be configured to display the betting scenario on the user interface of an application on which the gaming engine is running to thereby allow a user of the application to make wagers on the betting scenarios, for example, by buying shares of the betting scenario, as well as sell shares of the betting scenarios that have not yet occurred as described herein.

As used herein, shares are the equivalent of units of bets or can also be represented as dollars at risk or value at risk. The dollar or amount of value that a user is risking is represented as shares in various embodiments, but it will be appreciated that a number of different nomenclatures or methodologies can be used for representing the odds or dollars to be risked by a user.

Additionally, the gaming engine may be configured to set an initial price for each betting scenario and to dynamically adjust the price of the betting scenario as the betting scenario plays out in real time. In one embodiment the price of the betting scenario is related to a probability of that betting scenario occurring and the betting engine may update the price up or down as the betting engine determines that the betting scenario is more or less likely to occur. As described in more detail below, the gaming engine may take into account various inputs to set and update the price of each betting scenario.

For example, the gaming engine may be configured to select and display the betting scenario framework of “Player A will accomplish X (statistical feat) within Y (time period).” If the gaming event being administered, for example, is a football game featuring the Kansas City Chiefs against the Baltimore Ravens, the gaming engine may be specifically configured to select and display a betting scenario of “Patrick Mahomes will pass for 100 yards in the first half” based on statistical data obtained by the betting engine that, for example, users often place wagers on Patrick Mahomes and that users often place wagers on the number of yards quarterbacks will throw in the first half, among possibly many other statistical considerations.

The betting engine may be further configured to associate a price with the betting scenario based on the gaming engine's determination of the likelihood of Patrick Mahomes passing for 100 yards in the first half against the Ravens in this particular game. As will be described in more detail below, the price will range between 0-99 based on the percentage likelihood that the event will occur, and more likely, the price will range between 1 and 99 unless Patrick Mahomes is not playing in the game, in which the price will be zero. For example, the gaming engine may predict that there is a 55% likelihood that Patrick Mahomes will pass for at least 100 yards in the first half and therefore, the gaming engine may set the initial price at 55.

It will be appreciated that a price of 20 can also be represented as a moneyline number of +400, meaning that a $100 wager will win $400. Similarly, 25 can be represented as +300, meaning that a $100 wager will win $300 and a price of 50 can be represented as +100. Further, a price of 75 can be represented as −300, meaning the user has to risk $300 to win $100. The amount risked can be any amount that the gaming operator, betting exchange, or peer-to-peer user is willing to accept. Additionally, a price of 20 can be represented as 4× (or 5× if the convention includes the amount risked). Similarly, a price of 25 can be represented as 3× and a price of 50 can be represented as 1× (or 2× if the gaming operator chooses to include the amount risked.) Further, a price of 75 can be represented as 0.33× (or 1.33× if the convention includes the amount risked.)

Once the game begins, the gaming engine may continuously update the price of the betting scenario based on data obtained by the gaming engine about the game and based on the gaming engine's prediction as to the likelihood of the betting scenario occurring. For example, if Patrick Mahomes passes for 45 yards in the first minute, the gaming engine may update the price to 75 based on the gaming engine's prediction that it is now more likely that Mahomes will pass for 100 yards in the first half. Further, for example, if Mahomes does not pass for any more yards in the first quarter, the gaming engine may adjust the price to 35. Even though the examples given are based on set time periods (i.e., the first minute and the first quarter), as noted above, the gaming engine will continuously update the price of the betting scenario throughout the first half based on statistical information obtained about Mahomes' play, including not only historical statistical information known by the betting engine, but also statistical information obtained by the gaming engine from the particular game at issue via sports data as well as inputs from in-stadium users, as described in more detail below.

The gaming engine can be an artificial intelligence or machine learning module that can generate bets via a data feed or application protocol interface (API) for use by media companies, game makers, sports books, fantasy sports operators, and other third parties. In addition, the gaming engine can generate prices for the betting scenarios based on the probability (i.e., likelihood) of the betting scenario occurring. For example, the gaming engine may generate a betting scenario of Lebron James scoring eight points in the first quarter of a particular game and the betting engine may determine that this betting scenario has a value of 55 based on betting engine's prediction of the 55% likelihood of Lebron James scoring eight points in the first quarter of that particular game. As noted above, the gaming engine can update the prices of the betting scenarios in real-time as the probability of the betting scenario occurring changes throughout the duration of the sports gaming event.

In one example of a sports gaming event, a betting scenario generated by the gaming engine can be displayed on the interface of an application on a computing device (e.g., device). The computer device may include, but is not limited to, a personal computer, a mobile smart phone, or a tablet. In one embodiment, the user of the application is able to place a wager on a particular betting scenario (described in more detail below) using an interface (e.g., a bet selection interface) and the application is configured to update and maintain such user's point or cash total after the betting scenario has occurred or has not occurred.

In another example as described in more detail below, after the user places a wager, the user can sell their wager to another user or to the “house” at a later time in response to changes of the price of the wager (or even if the price remains the same).

In another example of a sports gaming event, a tournament in which multiple users place wagers on numerous betting scenarios based on a specified set of events (e.g., a specified game or a specified group of games) or based on a particular time frame (e.g., a single day, a single sports tournament, or a single season), wherein the point totals of each player are maintained for the duration of the specified set of events or time frame, and a winner is declared at the end of the tournament. It will be appreciated that there are countless other sports gaming events which involve at least one user placing a wager on at least one betting scenario that could be generated by, run on, and/or maintained by the application according to embodiments of the present invention.

As used herein, a betting scenario refers to a particular outcome (e.g., a player will hit a home run within the next three pitches) coupled with a price, i.e., a value assigned to the betting scenario that indicates the gaming engine's prediction of the likelihood of such event occurring or that indicates a value ascribed to the particular betting scenario by the gaming engine based on a set of rules provided to the gaming engine and the gaming engine's prediction of that event occurring. For any betting scenario, a user will have the ability to place a wager on the event occurring and will obtain a reward in the form of real money, pretend money, points, or another scoring method, if the event occurs and will not receive any money or points if the event does not occur.

According to another embodiment, a gaming operator, team, or media partner could conduct contests offering prizes or cash to in-stadium gaming users to entice the fans at the stadium to play in a gaming event. The prizes could be location specific, such as an instant seat upgrade for making winning bets or predictions in the first inning or first quarter, or there could be other stadium specific prizes such as locker room visit, free food or drink, etc. Through the use of inducements at the stadium, the gaming engine could receive data to determine prices for wagers for users and gaming operators offering different fantasy games, tournaments, or wagers involving the same bets.

According to another embodiment, gaming users could be asked to enter their seating information during an in-stadium tournament or to “check in” with the purpose of identifying a winner via an in-stadium announcement of an in-stadium tournament winner. It will be appreciated that by offering or creating specific tournaments where only live (i.e., in-stadium) attendees can play in the wagering contest or by creating free-to-play prediction games, the gaming engine is accumulating data that it can then use to inform rapid locking and closing of bets of all other gaming operators, exchanges, or peer-to-peer markets, where the stakes might be higher or where cash wagers may be offered.

As described in more detail below, the generated betting scenario can be displayed to a user such as via a mobile device application, and the user can place wagers on the probability that specific events that may occur within the duration of a live sporting event rather than merely the final outcome and that the price of any betting scenario can be dynamically adjusted depending on various factors including actual occurrences in the live sporting event as well as the number and size of wagers placed on that particular betting scenario by other users.

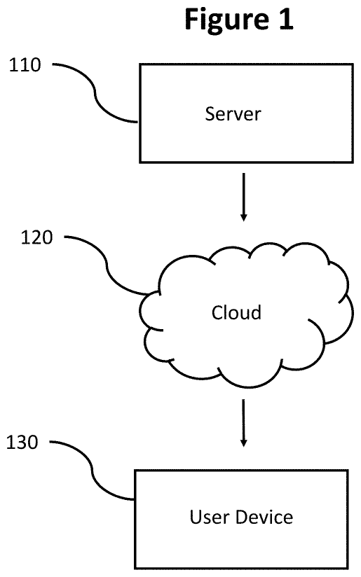

FIG. 1 illustrates a system block diagram for the operation of sports wagering using dynamic real-time pricing and trading according to an embodiment of the present disclosure.

Referring to FIG. 1, the server 110 can transmit data to and receive data from a computer network 120 such as the Internet. Further, the computer network 120 can transmit data to and data from a user device 130. The user device 130 may have an interface that can display a betting scenario and the price of the betting scenario generated by a gaming engine. Further, the user can use the user device 130 to place a wager on the betting scenario or trade a wager to another use via the interface.

In some embodiments, the server 110 can include a processor and memory storing instructions, where the processor executes the instructions to implement the gaming engine for managing the gaming event. While the terms “server,” “processor” and “memory” are used herein in the singular, embodiments of the present disclosure are not limited thereto, and may be implemented by multiple computer systems and/or computer servers, each of which may have one or more processors and one or more memories (e.g., different types of memory such as persistent memory and volatile memory). Therefore, unless otherwise explicitly described otherwise, operations that are described herein as being performed or implemented on a server and/or by a processor and memory may be construed as including being implemented on multiple servers and/or by multiple processors and memories, where the multiple servers may perform substantially the same tasks (e.g., operating in parallel), may perform substantially different tasks (e.g., perform different aspects of embodiments of the present disclosure), or combinations thereof.

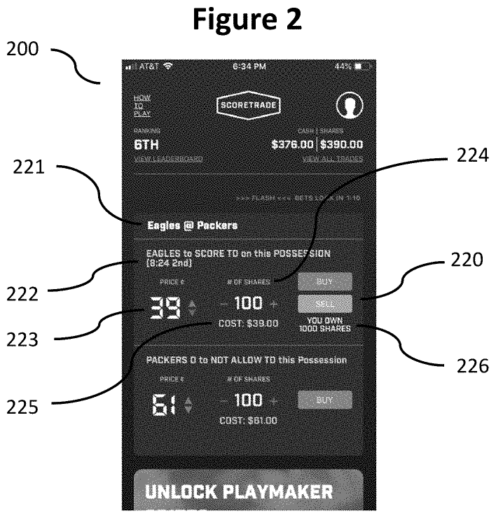

FIG. 2 illustrates an interface for displaying sports wagering using dynamic real-time pricing and trading according to an embodiment of the present disclosure.

According to FIG. 2, a generated betting scenario can be displayed on a bet selection interface 220 within application interface 200. In various embodiments, the application interface 200 can be run on a computing device. The computing device may include a personal computer, a mobile phone, or a tablet, but is not limited thereto. A user can place a wager on the generated betting scenario at the displayed price using the bet selection interface 220. Additionally, the user can sell a wager to other users via the bet selection interface 220. It can be appreciated that while the bet selection interface 220 is one method for placing a wager on a generated bet and various other embodiments, other methods and interfaces can be used for placing a wager or selling a wager.

Referring to FIG. 2, the bet selection interface 220 may include information about the betting scenario including the title of a sporting event 221, a betting scenario description 222, and the price 223. For example, the price 223 may be a value of a single bet share, wherein the bet selection interface 220 may also include the ability for a user to choose the total number of bet shares 224 that they would like to wager and which is also displayed by the bet selection interface. Additionally, the bet selection interface 220 can include the ability for the user to sell a wager to another user at the price 223. Further still, the bet selection interface can display the total cost 225 of the betting scenario, the number of shares 226 of the betting scenario owned by the user, and buttons that allow a user to take certain actions, such as the ability to “Buy” or “Sell” a certain number of shares. It will be appreciated that the bet selection interface 223 could also display other information associated with the betting scenario including, for example, the duration of a time limit placed on the betting scenario, the number of shares of that betting scenario held by other users, and the total value of the amount that a user has available to wager on betting scenarios.

It will be appreciated that the “Buy” price and the “Sell” for a particular betting scenario may be the same, but do not necessarily have to be the same. In one embodiment, the Buy price may be higher than the Sell price or the Sell price may be higher than the Buy price. In some embodiments, the gaming engine may calculate the Sell price based on its prediction of the likelihood of the betting scenario occurring (i.e., the Buy price) and then subtracting a particular percentage from the Buy price. In some embodiments, the difference between the Buy and Sell prices may reflect the amount of “confidence” the gaming engine has in its prediction of the particular gaming scenario. Accordingly, if the gaming engine were calculating the Sell price for the “house,” i.e., an entity responsible for rewarding users for the successful sales of the shares of their betting scenarios, the gaming engine may be configured to subtract a larger percentage of the Buy price to arrive at the Sell price for Buy prices that the gaming engine predicts to be more volatile.

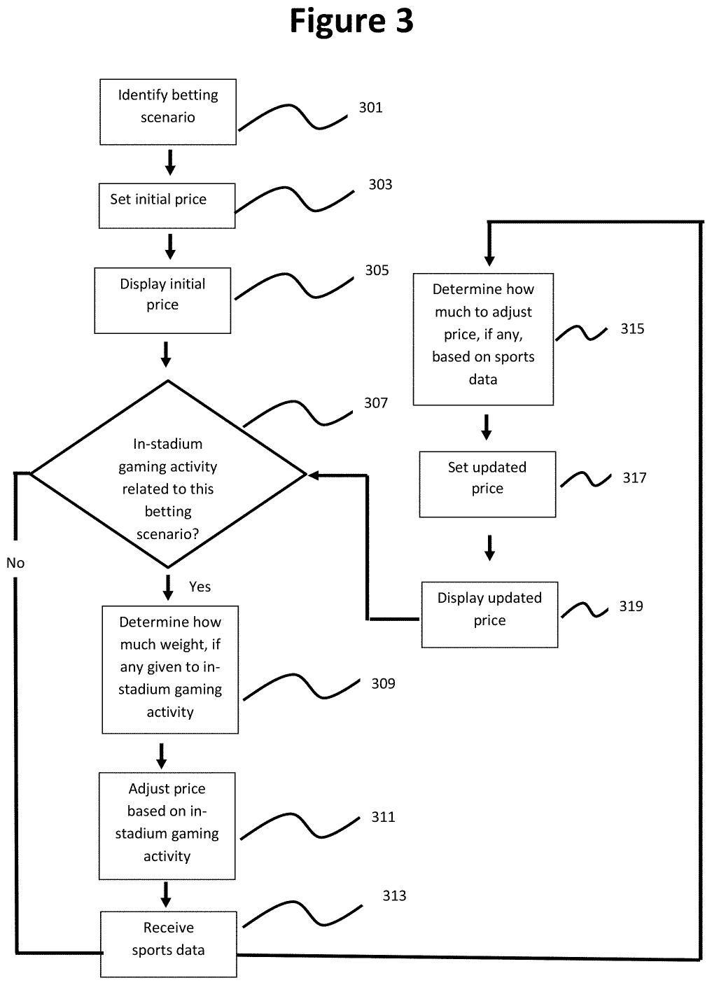

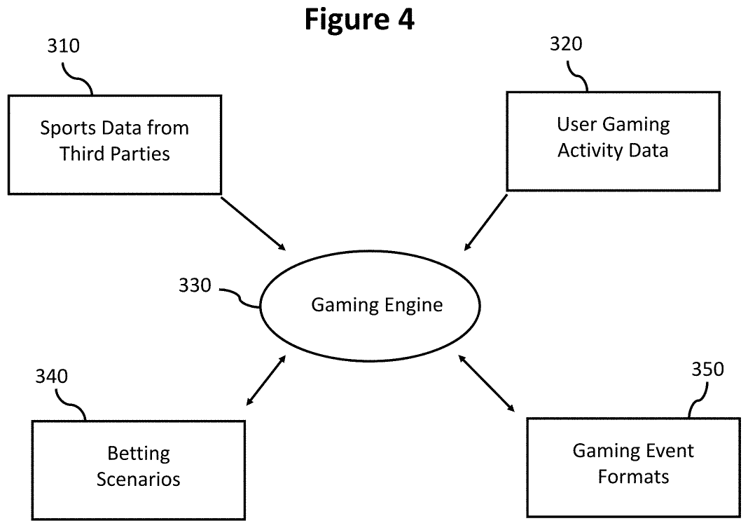

FIG. 3 illustrates a flow chart for the process of the gaming engine setting an initial price and adjusting the price based on various data considerations. Further, FIG. 4 illustrates a system block diagram for the operation of the gaming engine using dynamic real-time pricing and trading according to an embodiment of the present disclosure.

According to various embodiments and with reference to FIGS. 3 and 4, the betting scenarios 340 can be automatically generated or selected from a database by a gaming engine 330. In some embodiments, the gaming engine 330 can generate or select betting scenarios 340 using sports data 310 received, such as from third party providers, over a network (e.g., internet) as well as user gaming activity data, as described herein. The sports data 310 can include, for example, statistical information about the most recent play, a player's current stats, a player currently in the game, a recent injury, a launch angle of a ball, the distance traveled by a ball, or other information about the live sporting event. The user gaming activity data 320 can be, for example, the number of shares bought, sold, and/or traded by users of the gaming engine 330, the amount of money transacted by users of the gaming engine 330, and the physical locations of the users that are participating in a gaming event or otherwise using an application that is connected to the gaming engine 330.

It will be appreciated that the amount of data about particular sporting events that is tracked by available technology is significant and that the gaming engine 330 can use any of this data by itself or in combination to generate, select, and price betting scenarios 340.

In one embodiment, the gaming engine 330 can take into account different types of gaming event formats 350 and automatically generate betting scenarios 340 that are relevant to a particular gaming event. The gaming event formats 350 may include a single game, a single team, a multi-game, a day long, fantasy, player props, sequential player props, possession-by-possession, hole-by-hole, time-limited, inning-by-inning, or other sports gaming event formats.

In one embodiment, the gaming engine 330, after having selected a particular betting scenario, will be able to determine, based on data associated with the particular betting scenario, the stadium, arena, field, or other event location of the particular betting scenario. Based on this knowledge of the betting scenario location and based on the gaming engine's 330 ability to also determine the location of users placing wagers on the betting scenario, the gaming engine can correlate a user's location to the betting scenario location and can place additional weight as appropriate on actions taken by users it determines to be at the same location as the location of the betting scenario, as discussed in more detail below. In other words, the gaming engine 330 can place more weight on actions taken by users that the gaming engine determines to have a direct, live view of the sporting event relating to a particular betting scenario, and who thereby have access to information about the sporting event before others who may be getting their information from a video or audio feed of the event which may be delayed, even if only by a short time, from the live action.

In one example, the gaming event being administered may be a real-time in-game fantasy sports tournament which allows a user to choose a roster of players, to buy and sell shares of the players during the games played by such players, and to accumulate as many points, dollars, or other value to win the tournament. In other words, a “fantasy” sports tournament may be a gaming event that allows users to create an environment where the user can act as a “general manager” to assemble their own team, to keep track of various statistical attributes of that team, and compare their team to other teams based on the same statistical attributes. It will be appreciated that there are a countless number of ways to construct a fantasy gaming event, some of which will be described herein.

In some embodiments, the fantasy gaming events can be compressed into micro-events rather than a full game fantasy event, a full day fantasy event, or a full season fantasy event. For example, the fantasy sports tournament may be a 1-quarter fantasy event, or 1-inning fantasy event, and the fantasy gaming event can have a duration across either part of a game, across one game, or across multiple games. Fantasy sports tournament games may involve an entry fee of real money or another “fee,” such as tokens of value, known to all entrants with a prize pool pre-determined and offered by a gaming operator (e.g., a human-based organization or entity overseeing the operation of a gaming event).

In another example, the gaming event may be a college basketball tournament where the gaming engine 330 generates betting scenarios 340 for each team remaining in the tournament to win its next game, wherein prices could be set for each remaining team, for example, to win its next game or to win the whole tournament as the tournament progresses.

Based on the gaming format selected, the gaming engine 330 can then offer particular betting scenarios 340 that are directed towards the selected gaming format. For example, if the gaming event selected is an entire game, then the gaming engine 330 can generate betting scenarios 340 directed to events that may occur over the entire duration of the game (e.g., the total number of points a particular player may score in the game) and it may also generate betting scenarios 340 directed to events that may occur over less than an entire duration of the game (e.g., the total number of points a particular player may score in the first quarter, second quarter, or first half of the game, among many other scenarios). If the gaming event, on the other hand, is only directed to a particular inning of a baseball game, then the gaming engine 330 could be configured to, for example, generate betting scenarios 340 for how many pitches a particular pitcher may throw in that inning or how many runs may be scored by one or both teams in that inning. As will be appreciated, there are countless scenarios that could be generated by the gaming engine 330 based on the type of gaming event being administered.

The gaming engine 330 may be configured to choose from various betting scenario 340 frameworks and assign specific variables (e.g., players, point values, and time period, among others) such that specific betting scenarios 340, including initial prices, can be generated for each game. Further, it will be appreciated that the gaming engine 330 may generate betting scenarios 340 for a full game, for a certain portion of a game, or for a certain game scenario whether the gaming event includes a single game or multiple games. In one embodiment, the gaming engine 330 is configured to review a library of betting scenarios 340, logic, season statistics, recent player performances, and the players on particular teams to generate betting scenarios 340 to offer to the participants of the gaming event.

By way of example, the gaming event being administered via an application using the gaming engine 330 may be a football game between the Green Bay Packers and the Philadelphia Eagles. In one embodiment, the gaming engine 330 can follow the Packers-Eagles game using the sports data 310 received from a third-party as well as input received from and or derived from in-stadium users via, for example, their buying of at least one betting scenario 340, their adding to their position of at least one betting scenario 340, and/or their selling of at least one betting scenario 340.

In one embodiment, the gaming engine 330 may be configured to evaluate all of the betting scenarios 340 that may have historically been offered when the gaming event is a single football game. From that list, the gaming engine 330 may be configured to offer a certain number (or all) of such betting scenarios 340 to the participants taking part in the gaming event. In one embodiment, the gaming engine 330 could be configured to offer the five most popular betting scenarios 340 based, for example, on the number of transactions historically occurring on such a scenario or the number of betting points historically wagered on such a scenario.

The gaming engine 330 may be further configured to offer betting scenarios 340 that are historically the most popular betting scenarios 340 for a particular gaming event. In the above example of the Packers-Eagles football game, for example, the gaming engine 330 may be configured to offer betting scenarios 340 reflecting the likelihood that either team will win the game, the likelihood that both quarterbacks will combine for more than three touchdowns, and the likelihood that any particular running back will rush for at least 100 yards, if those scenarios are the ones that have been wagered on the most number of times or have had the most value wagered on based on calculations by the betting engine for a particular time period, for example, the last year. Further, in one embodiment, the gaming engine 330 may be configured to monitor the game statistics and the wagering action on a particular gaming event and, as such, remove certain betting scenarios 340 and add certain betting scenarios 340 as the game progresses.

Continuing with the Packers-Eagle example from above, the gaming engine 330 may be configured to generate and offer a betting scenario 340 that the Packers quarterback will complete his first pass to a particular wide receiver that has been performing well over his previous two games. As the Packers' possession progresses, the gaming engine 330 could be configured to remove the initially offered betting scenario 340 and to be able to generate new betting scenarios 340 based on recent plays and to generate betting scenarios 340 involving various players.

When generating or selecting betting scenarios 340, the gaming engine 330 can consider the historical statistics of the players in the live sporting event, and may, for example, be configured to place more weight on more recent historical statistics. For example, the gaming engine 330 can consider that Aaron Rodgers is a top quarterback in a quarterback-driven league in view of his recent and historical statistics, that he is a former Most Valuable Player (MVP) recipient, that he is a central focus of the Green Bay Packers' offense, that he recently threw for 345 passing yards, and that when Rodgers has a statistically good game, the Packers often win. Based on some or all of these considerations (as well as possibly many other considerations), the gaming engine 330 could be configured to generate betting scenarios 340 on Aaron Rodgers reaching certain achievements within a particular game. For example, the gaming engine 330 can generate a betting scenario 340 that Aaron Rodgers will throw three touchdowns in the current game, that the Packers will win the game by more than five points, and that the Packers will have more than fifty rushing yards in the first half.

In one embodiment, the gaming engine 330 is configured to generate and offer betting scenarios 340 that are of high volatility, in other words, betting scenarios 340 whose price will fluctuate dramatically during a particular possession or period of time. Particularly, the gaming engine 330 will be able to identify such high volatility betting scenarios 340 based on its analysis of the sports data 310 as described above and of historical data that relates to similar situations. For example, a highly volatile situation may occur regarding the outcome of a game where one team takes the lead late in the game and then the other team receives possession of the ball to try to retake the lead before the game clock expires. It will be appreciated that the gaming engine 330 could learn these types of situations from analyzing the significant amount of historical sports data 310 and could be configured to offer betting scenarios 340 when the gaming engine 330 encounters such situations in the gaming events being administered using the gaming engine 330.

In one embodiment, continuing the Packers-Eagle example discussed above, the gaming engine 330 may be configured to evaluate at least one of, and more likely, many factors that could influence betting scenarios 340. Such factors may include, for example, the score, the time remaining, the most active statistical players in the game, whether there is a high-volatility situation in the game, whether there is a likely lead change based on field position, the weather conditions, the likelihood that the Packers may attempt to gain a first down or score a touchdown on fourth down versus kicking a field goal, among many other considerations.

According to various embodiments, the price 223 of the betting scenario 340 can be automatically generated and/or selected by the gaming engine 330. In one embodiment, the price 223 can be represented as a number 0-100, and can be based on the probability (i.e., likelihood) that the betting scenario 340 will occur. For example, a betting scenario 340 generated by the betting engine and displayed on the bet selection interface 220 may have a 75% probability of success and, therefore, the price 223 may be 75. If the betting scenario 340 occurs, then the probability will become 100% and the price 223 will become 100. If the betting scenario 340 does not occur, then the probability will become 0% and the price 223 will become 0. After a betting scenario 340 closes (i.e., the probability becomes 100% or 0%), the users that own shares of a successful betting scenarios 340 can receive 100% of the betting scenario 340's maximum possible value for each share they own. It will be appreciated that the price of the betting scenario 340 does not have to be directly tied to the percentage likelihood of the betting scenario 340 occurring, but rather that the price could be a different value assigned by a formula taking into account the likelihood of the betting scenario 340 occurring.

In one embodiment, the gaming engine 330 is configured to predict the probability of a betting scenario 340 occurring, and thus be able to set a price for that betting scenario 340, based on, for example, the sports data 310 received from a third-party provider, sports data 310 received from users of an application including the gaming engine 330, and historical data. In the Packers-Eagle example described above, such data will allow the gaming engine 330 to determine, for example, whether the Packers offense is better than an average offense, whether the Packers quarterback is better than an average quarterback, whether the Eagles defense is better than an average defense, how often does the Eagles defense give up a rushing touchdown versus a passing touchdown versus a field goal depending on where the offense is on the field, among many other considerations.

According to various embodiments, the price 223 can change in real time as the probability of the betting scenario 340 occurring changes. For example, the bet may be that a football team will score a touchdown on its current possession. If the football team is 80 yards from scoring a touchdown, the gaming engine 330 may determine that the probability of scoring a touchdown may be lower and thus the price 223 may also be lower.

As the possession continues, the gaming engine 330 may determine that the probability of scoring the touchdown fluctuates dynamically based on the play of the game. Accordingly, as the probability of scoring the touchdown fluctuates, the price 223 may also fluctuate according to the probability of the event occurring. For example, if the team gains yards and moves closer to scoring the touchdown, the gaming engine 330 may determine that the probability of the betting scenario 340 occurring, i.e., a team scoring the touchdown, may increase and therefore, the gaming engine 330 may automatically increase the price 223. On the other hand, if the team loses yards and moves further away from scoring a touchdown, the gaming engine 330 may determine that the probability of scoring the touchdown may decrease and therefore, the gaming engine 330 may decrease the price 223. In one embodiment, the fluctuations of the price 223 may be represented in real time on the bet selection interface 220.

In one example, the gaming engine 330 may have generated and offered the betting scenario 340 of Aaron Rodgers completing two passes on the Packers' current possession. Accordingly, the gaming engine 330 may be configured to evaluate the probability of this betting scenario 340 occurring, and therefore, be able to set a price for this betting scenario 340, based on a number of statistical factors. For example, the gaming engine 330 may consider the number of times Aaron Rodgers has historically completed two passes on a possession, the number of times Rodgers has completed two passes on a possession this season, the number of time Rodgers has completed two passes on a possession in this game, the strength of the Eagles defense, the Packers field position, the score of the game, how much time is remaining in the half or in the game, and the wind direction and strength, among many other considerations.

To continue with this example, if Rodgers throws an incompletion on first down, the betting engine can be configured to reevaluate the likelihood that Rodgers will still complete two passes on this possession and thereby readjust the price as necessary. For example, the gaming engine 330 may be configured to consider the percentage of times the Packers gain a first down after gaining no yards on first down, how often Rodgers throws again after throwing an incompletion and the like, as well as the score, time, and weather conditions that were the same or similar to (or, as the case may be, significantly different from) the previous play. For example, the gaming engine 330 may predict that it is more likely that Rodgers will need to throw the ball after picking up no yards on first down and therefore, the gaming engine 330 may increase the price of the betting scenario 340 based on the higher likelihood of its occurrence.

In some embodiments, the user can sell a wager based on changes to the price 223. For example, a user can place a wager that a football team will score a touchdown on its current possession. At the time of the wager, the price may have been 20. As the possession progresses, the football team may move closer to scoring a touchdown. As a result, the gaming engine 330 may determine that the probability of the betting scenario 340 occurring may increase and the gaming engine 330 may increase the price. For example, in this scenario, the price of the wager may increase to 50. The user can choose to sell the wager at that point and earn a profit of 30 per share. Alternatively, the user can choose to keep the wager to see if the betting scenario 340 will occur and thereby reap the reward for such occurrence of the betting scenario 340.

As noted above, player statistical targets, likelihood of scoring events, or outcomes for the entirety of the game, and during arbitrary time periods within a game, and other sports situations, the gaming engine 330 produces and updates probabilities as new data is received, including sports data 310, data regarding which betting scenarios 340 and how many shares users are buying and selling, and what proximity the gamer has to seeing the action, whether live or watching the game on television or mobile devices, and the extent of the latency.

In some embodiments, the gaming engine 330 may be configured to follow a live sporting event by receiving sports data 310 from third party providers. The sports data 310 may include the most recent play, a player's current stats, whether a particular player is currently in the game, a recent injury to a particular player, and other information about the live sporting event.

Particularly, the gaming engine 330 may be configured to receive statistical data and other data, for example, via the internet, about a particular live sporting event and may be configured to analyze such data to set an initial price for a particular betting scenario 340 and to adjust the price for that particular betting scenario 340 as the live sporting event progresses.

To that end, the gaming engine 330 can be configured, for each betting scenario 340, analyze particular statistical data to set an initial price depending on the betting scenario 340 and based on the gaming engine 330's prediction as to the likelihood of the betting scenario 340 occurring. Because the gaming engine 330 can be configured to receive a significant amount of data for each live sporting event, it will be apparent that not all of the data received for each sporting event will necessarily be relevant to each betting scenario 340 that can be generated or selected for that sporting event. Rather, the gaming engine 330 may be configured to evaluate only particular statistics that relate to the specific betting scenario 340 at issue and it will be appreciated that the gaming engine 330 can further be configured to place more or less weight on particular statistics to set prices for each betting scenario 340. Additionally, the gaming engine 330 can be configured to evaluate, over time, which particular statistics are more relevant to and are better predictors of a particular betting scenario 340 occurring.

In embodiments, when generating the price 223, the gaming engine 330 can predict the probability that the betting scenarios 340 will occur using various methods, which may include, but is not limited to, an algorithmic calculation, a human-selected probability, or a market-based probability based on weighing supply and demand indicators. As will be appreciated, the gaming engine 330 may be configured to update the probabilities and prices as the play in a sporting event progresses. Following are several examples of how the gaming engine 330 may determine an initial price of a betting scenario 340 and then update that price throughout the betting scenario 340 by updating its prediction of that betting scenario 340 occurring.

With reference also to FIG. 3, in one embodiment, the gaming engine 330 may automatically generate or select from a database a betting scenario 340, i.e., the gaming engine may identify the betting scenario 301 for which it will determine the initial price 303.

In one embodiment, for determining the initial price 303 for a given betting scenario 340, the gaming engine 330 may first start with historical statistics. For example, the initial historical analysis may reveal that teams in the most recent decade have yielded far more first downs in particular situations, or in almost every situation, than in the decades prior, diminishing the weighting of the earlier decades.

Additionally, if the betting scenario 340 is for the Green Bay Packers to get 3 first downs on this possession, and the game situation is that Green Bay is starting at its own 25 yard line with 2 minutes to go in the game and trailing by 7 points, the gaming engine 330 may do the following.

First, the gaming engine 330 may draw on a historical database that has been previously modeled and tabulated and that shows how many first downs have happened in a significant number of NFL games for a certain time period, for example, with two minutes remaining and offensive teams starting on their own 25 yard line. From such historical database, the gaming engine 330 could be configured to calculate the average number of yards per play on first down, on second down, on third down for teams in this situation and in similar situations.

Further, the historical data may be analyzed and pre-sorted further to suggest that, for example, yards per play on first down from a team's own side of the field is much higher than yards per play on the opposing side of the field. Additionally, the machine learning algorithms may be configured to analyze, for example, differences in the quality of teams, quality of quarterbacks, time left in games, score of the games, timeouts left, whether it is early in the game or late in the game, quality of offenses, and quality of defenses, and weather impacts such as rain or cold. The machine learning algorithm may find a set of different correlations for expected yards on first down based on the historical analysis, and be configured to provide a pre-indexed weighting of how much each factor should impact the prediction of the probability.

Additionally, the gaming engine 330 may be configured to analyze a plot analysis of what the average NFL yardage gained on first down and ten yards to go versus second and four yards to go. The X axis may have the down, one through four. The Y-axis may have the yards to gain for a first down. For each situation, first and 10 or 3rd and 4, the gaming engine 330 would be able to determine the average number of yards gained on 3rd and 4 versus 1st and 10. The plots could be generated and maintained in a database as they are not dependent on real-time or live data being received by the gaming engine 330.

In some embodiments, the gaming engine 330 could be configured to assign the framework to a machine learning algorithm to generate a random forest, whereby the gaming engine 330 will examine and generate millions of models to analyze the millions of possible game situations taking into account, for example, time remaining, field position, timeouts left, penalties, previous games statistics, quarterback play over previous games, and to determine what the variances are within each situation, and how it is likely any particular situation is to impact the yardage likely to be gained for the millions of possible permutations. With this data, the gaming engine 330 can be configured to predict a probability for every likely down for millions of profiled situations.

In some embodiments, once the model is trained via machine learning, it may or not need to call on the stored data any longer, but can simply call upon the relevant in-game data needed and weigh the various factors as the model has determined vital for that team, that day, that quarterback and the like.

Given the millions of probable situations, in one embodiment, a non-linear mathematical model may be used to predict the distribution of probabilities.

If, for example, the gamine engine in real-time determines that an entertaining betting scenario 340 might be for users to predict whether the Packers will get 3 first downs on this drive, the gaming engine 330 may draw upon the cumulative probabilities for all of the successive downs, and predict the probability of the Green Bay Packers to gain three first downs on a particular drive. Once the first play is run, the model once again will run to predict the probability of picking up three first downs given that the first play was, for example, an incomplete pass. In one embodiment, the gaming engine 330 could obtain the number of yards gained on first down from a data feed from a 3rd-party provider.

In that case, starting from 2nd and 10 from Green Bay's own 25 yard line, the gaming engine 330 may be configured to predict the likelihood of the Green Bay Packers picking up a total of 10 yards on the next three downs, given the score of the game where Green Bay is trailing with less than 2 minutes. Accordingly, the gaming engine 330 may then tabulate that if Packers do pick up a first down, what is the probability that they pick up another first down, and yet another first down once the second first down is picked up, and then the gaming engine 330 will generate a new probability.

In another example, the gaming engine 330 may have generated the following betting scenarios 340 for the Packers-Eagles game:

Aaron Rodgers to PASS FOR 250 YARDS.

Green Bay Packers to WIN THE GAME BY 4 POINTS.

All Green Bay running backs to cumulatively RUSH FOR 100 YARDS.

Green Bay Packers to WIN THE COIN TOSS.

As described above, the gaming engine 330 can be configured to take into account numerous different statistics and be configured to assign a weight to each statistic or other data to generate an initial price for each betting scenario 340.

For example, the gaming engine 330 may be configured to assess the weather and to assign a weight factor to how the weather may influence each betting scenario 340. Particularly, if the game is being played in December at Green Bay's stadium, Lam beau Field, which is an open air stadium, and the gaming engine 330 receives data that heavy snow is falling, the gaming engine 330 may determine that it is less likely for Aaron Rodgers to throw for 250 yards than if the weather is sunny, and thereby the gaming engine 330 may assign a weight to the weather to influence the likelihood of Rodgers reaching the 250 yard passing target. However, the gaming engine 330 may also predict that the snowy weather has no effect on Green Bay winning the coin toss because that betting scenario 340 is a 50/50 proposition that is not affected by the weather. Similarly, the gaming engine 330 could assign weights to the weather's potential effect on Green Bay's ability to win the game by 4 points, and, based on historical statistics of games played at Lam beau field during heavy snow, may in fact determine that it more likely that Green Bay will win by 4 points due to the weather. Finally, the gaming engine 330 may also be able to determine that while the total number of offensive yards may be lower for a game played in heavy snow, which will affect both passing and running the football, that the probability of Green Bay's running backs cumulatively reaching 100 yards may be about the same as if the weather was sunny due to the fact that Green Bay is more likely to run the ball than pass the ball during heavy snow.

Having set an initial price 303 for a betting scenario 340, the gaming engine 330 can be configured to continuously adjust its prediction for the betting scenario 340 occurring as the game progresses, and thus, to continuously update the price based on its updated predictions. As described above, in one embodiment, the gaming engine 330 may use sports data 310 about the game to update its prediction.

Further, as noted above and with reference now to FIGS. 3 and 4, the gaming engine 330 can be configured to receive user gaming activity data, including information about the buying or selling of shares of a particular gaming scenario, in addition to receiving sports data 310 regarding the statistics involved in a particular betting scenario 340. As such, the gaming engine 330 may be configured to incorporate such user gaming activity data into its prediction as to whether a particular betting scenario 340 is more or less likely to occur.

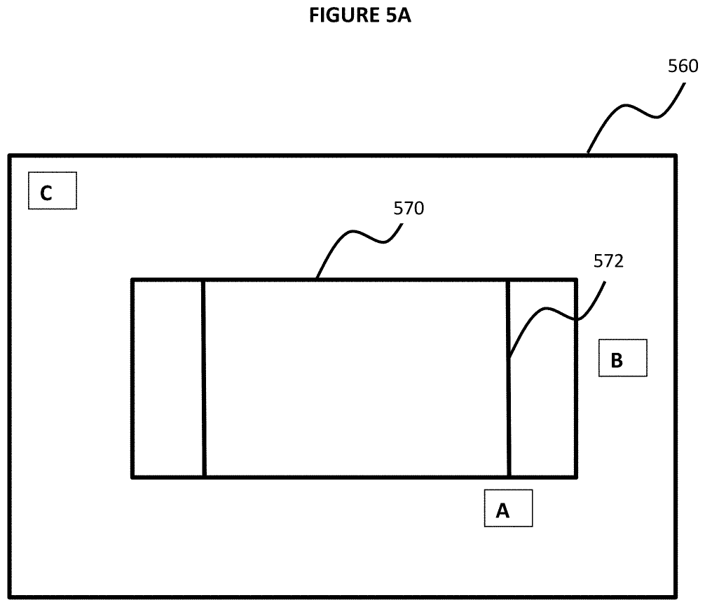

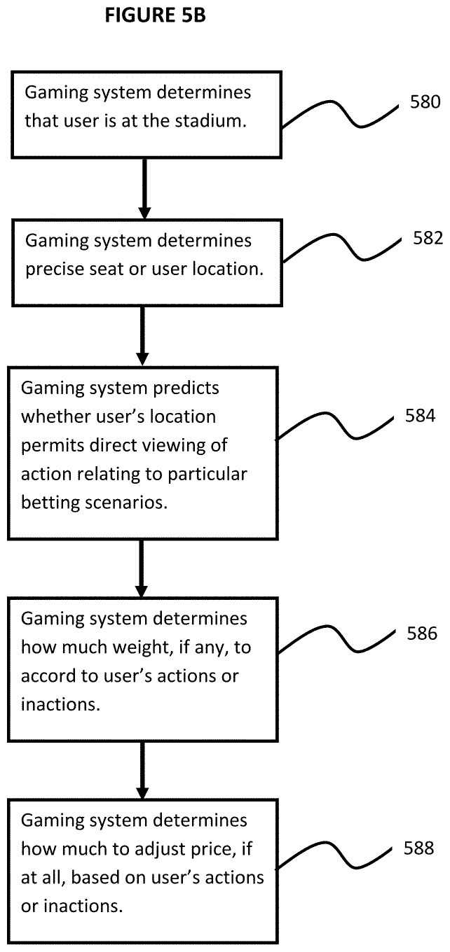

With reference now also to FIGS. 5A and 5B, it will be appreciated that in some cases, a user of the gaming application will be at the stadium, arena, other event venue 560 and watching a game in person and have the ability to wager on betting scenarios offered by the gaming engine for that particular game. Because of an inherent delay in the relaying of a video and/or audio feed, any television, radio, or internet broadcast or stream is necessarily behind the live moment that a sporting action takes place. In other words, the viewer at home who is watching a game on a “live” feed is still not watching it simultaneously to a user at the stadium. As such, an in-stadium user has a potential advantage of seeing a play or another relevant occurrence (e.g., an injury or a substitution) before a user who is watching the same game on a “live” broadcast.

The gaming engine may be able to determine and track a user's location in a number of different ways, for example, via a user's mobile carrier, a user's check-in through an application, automated location tracking from the application, tracking the user's car in the stadium parking lot, the proximity of one user to another user at the stadium, through social media tracking, or any other permutation or mechanism of determining that the user is at the stadium or can otherwise view the sporting event in real time.

In some embodiments, the gaming engine can use a user's mobile phone's geo-location data to determine a user's seat location. Accordingly, the gaming engine 330 can use the geographic location of a user and the gaming engine's knowledge of the betting scenario location to correlate the user's location to the betting scenario's location, i.e., the user having access to view an event as it happens rather than receive information through a video or audio feed or through another source that is not simultaneous with the event. Accordingly, the gaming engine 330 can use the correlation of the user being at the event to predict the likelihood of the betting scenario 340 occurring, and thus to adjust the price 223 as the game progresses. More particularly, in one embodiment, the gaming engine 330 may be configured to place a higher weight on the buying and selling of shares, or the lack of buying and selling of shares, of users that are watching the sporting event related to the betting scenario 340 at the sporting event venue because such users may have access to information from the sporting event before those users who may be watching the event on a video feed or other feed rather than being at the event.

In one embodiment, the gaming engine will have access to stadium maps and seating locations to model and determine a range of vantage points for viewing the outcome of certain plays, which may have an impact on the outcome or pricing of bets from the gaming engine. For instance, all of the stadiums in the NFL, NBA, College football, college basketball, MLB, and NHL may be mapped with both geo-location data and seat locations, both in relation to the sport and field of play 570. Further, golf courses can also be mapped to see where a user is positioned in the gallery and what hole the user is best able to view. It will be appreciated that any stadium, arena, venue 560, field of play 570, or other location where an event is being held may be mapped and be accessible to the gaming engine so that the gaming engine can identify vantage points which may be advantageous for providing a user the best access to view a particular play or outcome.

According to one embodiment, a user may be watching a game in person at the stadium (i.e., an in-stadium user) or at another location where a game is being played and where the user can view the game live. Further, the in-stadium user may be participating in a gaming event and therefore, the in-stadium user may be buying shares or selling shares of a particular betting scenario 340.

Due to a delay between occurrences of a live event and the broadcast of such occurrences to a user's device or to another medium viewable by the user, the in-stadium user may see a play in the game before other users following the game on other mediums such as on a live box score, play-by-play data, social media feedback, or on a live broadcast. In response to viewing certain game action, such as seeing a play or seeing a particular changing of personnel, an in-stadium user may take certain actions such as buy or selling shares of a particular betting scenario 340, or even multiple betting scenarios 340 from the same game.

Because the in-stadium user may be able to view the game action before users who are not in the stadium or otherwise able to view the game action live, the buying and selling of shares of betting scenarios 340 by the in-stadium user may provide an indication to the gaming engine 330 of the likelihood of those betting scenarios 340 occurring before the gaming engine 330 receives the sports data 310. Further, because the gaming engine may have access to the particular stadium map and to the particular seating locations that may provide advantageous vantage points, the gaming engine can correlate user data from in-stadium users and their location. Particularly, depending on a user's location within a stadium, the in-stadium user's gaming activity may be indicative of the most recent play or other game activity and can suggest that the probability of a betting scenario 340 outcome has changed before the gaming engine 330 receives the sports data 310 for that particular game.

In another embodiment, seating information can also be correlated to databases of season ticket holders, information from ticket services, information from the teams themselves, or information from the mobile operator. In one embodiment, providers of seating information can participate in the gaming revenues on a micro-transaction basis, fixed fee, a percentage of gaming deposits, or wagering activity, or overall profitability of the gaming event offered.

Accordingly, in one embodiment, the gaming engine 330 may be configured to analyze, and possibly give greater weight to gaming activity from in-stadium users for particular betting scenarios 340 even if the gaming engine 330 has not yet received the updated sports data 310 from that particular game. As such, the gaming engine 330 may be configured to adjust its prediction of the probability of certain betting scenarios 340 occurring based on such in-stadium user gaming activity and their location in the stadium rather than, or in addition to, the sports data 310 it receives.

For example, the in-stadium user may own shares of a betting scenario 340 that a baseball player will hit a home run in his current at bat. If the baseball player grounds out, the in-stadium user may be able to see that the player has grounded out before other users and will therefore know that the probability of the player hitting a home run will decrease to zero. The in-stadium user may then try to sell shares of the betting scenario 340 before the price 223 decreases to zero. On the other hand, if the player hits a home run, the user may try to buy shares of the betting scenario 340 before the price 223 increases to 100 and is no longer available to be purchased.

In another example, with reference to FIGS. 5A and 5B, the gaming engine 3300 may initially determine that a user is at the event location (reference 580) using, for example, the user's mobile device geo-location data. Once the gaming engine 330 determines that a user is at the stadium, the gaming engine may then determine a precise seat location or other precise location of the user (reference 582). For example, the gaming engine 300 may determine, for the schematic football stadium 560 shown in FIG. 5A, that User A is located at a seat next to the field and directly across from one of the goal lines 572, that User B is located directly behind one of the goal posts, and that User C is located in the upper corner of the upper deck of the stadium.

In one embodiment, the gaming system may be able to predict for each betting scenario being offered relating to the particular game which Users A, B, and C are attending whether the vantage point of any of the users offers a direct view of any actions relating to particular betting scenarios (reference 584) and which may be useful in determining the outcome of a particular play.

For example, the gaming engine 330 may determine that User A, sitting close to the field 570 and directly across from the goal line 572 would have a good view to determine whether a ball carrier crossed the goal line and would likely be able to determine whether the ball carrier scored a touchdown on a close play whereas the gaming engine may determine that User C would not necessarily be able to tell whether a touchdown was scored on a close play. In another example, the gaming engine 330 may determine that User B seated directly behind the goal post would be able to immediately determine whether a field goal attempt was converted. As such, the gaming engine 330 would be able to determine that a Buy signal or input from these respective users when there is a potential touchdown or a field goal attempt being made towards that user is likely to be extremely accurate and, accordingly, the gaming engine may assign a weight (reference 586) to this input that is greater than weight it assigns to other in-stadium users or non-in-stadium users. Once the gaming engine 330 has determined how much weight to accord to inputs from in-stadium users, it may predict whether the betting scenario may have occurred or not occurred, and it may then adjust the price of the betting scenario based on such prediction (reference 588). In addition to adjusting the price up or down when the gaming engine 330 leaves the betting scenario open, the gaming engine may, upon determining that the betting scenario likely occurred, close the betting scenario such that no further action may be taken on that betting scenario.

It will be appreciated that in some cases the gaming system may accord different weights to differently-located users to adjust the price of some betting scenarios depending on their specific seating locations and that in some cases, the gaming system may accord the same weights to such in-stadium users (but more weight than non-stadium users). For example, if the betting scenario is for a quarterback to throw for 150 yards in one half and the quarterback has already thrown for 140 yards in the half, the gaming engine 330 may predict that if all three Users A, B, C essentially simultaneously buy shares of the betting scenario, that the quarterback completed at least a 10-yard pass such that the betting scenario occurred and may close the betting scenario even though the gaming engine may not have received any sports data confirming the pass completion or the quarterback passing for 150 yards in the half.

On the other hand, if the betting scenario is for a kicker to make a field goal attempt and User A sells shares of the betting scenario while User B buys shares of the same betting scenario, the gaming engine 330 may accord more weight to User B's buying of shares than User A's selling of shares because the gaming engine 330 could determine that User B sitting behind the goal post would be in a better position to determine whether the field goal was made than User A who is sitting next to the goal post.

Further, if a number of other users in close proximity to the originally identified user in the end zone also enter Buy signals or orders for a betting proposition for a field goal to be successful, the gaming engine may be configured to increase the level of confidence in the Buy signals (i.e., increase the amount of weight accorded to those betting inputs) that the field goal was likely successful. Based on such a weighting system, and because the gaming engine is configured to perform analysis at micro-seconds between gaming inputs. the gaming engine may decide to instantly lock the betting scenario upon the action of the in-stadium user so that no further wagers can be placed on that particular betting scenario.

In another example, a first user might be on the first base line in a baseball game, where the coordinates, elevation, and/or seat location known to the gaming engine may allow the gaming engine to predict that location to be an advantageous viewing angle to determine if a hitter who puts a ball in play, with a fielder throwing to first base, has reached base safely or has been thrown out. Similarly, if the gaming engine determines that a second user is seated behind the outfield, the gaming engine may predict that the second user is not going to have as advantageous a vantage point as the first user. Accordingly, the gaming engine may be configured to weigh the input from the first user who is seated in close proximity to first base as significantly higher than the second user who is seated in the outfield.

In one embodiment, the gaming engine can build correlations between the social interactions of in-stadium users and their social circles to more accurately predict the occurrence of a betting scenario before receiving confirmation of the occurrence (or lack of occurrence) of that betting scenario from the sports data. For example, the gaming engine could determine over a set of intervals or games, that when a particular user is at the stadium and a member of that user's social circle has extremely accurate betting patterns, the gaming engine could ascertain that the particular user at the stadium is likely transmitting wagering information via voice, video call, or other real-time methodology to the member of his social circle. As such, the gaming engine may assign a higher weight to wagers made by the member of the user's social circle even though the gaming engine may determine that such social circle member is not at the stadium.

In one embodiment, a user's social circle may be determined from that user's social media accounts, their uploaded contact lists, referrals, and the like. Additionally, the gaming engine can monitor a user's social media such as Twitter to determine if that user or set of that user's followers are able to know gaming outcomes, or are reacting to gaming outcomes before the gaming engine receives data from a sports data provider or broadcast feed.

Additionally, in another embodiment, a set of users can be on a video call or audio chat or a mix of both, wherein the gaming engine, through the use of facial or image-based recognition technology, is configured to determine whether a user is at the stadium. Further, the gaming engine may be configured to analyze a voice-to-text parser to gauge user reactions to predict the occurrence of a betting scenario and determine if a betting scenario needs to be closed or not. It will be appreciated that by analyzing the conversation between users, the gaming engine may be able to predict the occurrence of a betting scenario even if such users have not taken any wagering actions with respect to that betting scenario.

In another example, if the betting scenario 340 is for a particular football team to make a first down on their current possession, the gaming engine 330 may have assigned a particular price to that betting scenario 340 at the start of the possession. If the team gains nine yards on first down, the gaming engine 330 may receive such data from the sports data 310 feed and predict that the betting scenario 340 is now more likely to occur. However, if the gaming engine 330 receives information about a number of in-stadium users buying the betting scenario 340 before the gaming engine 330 receives the sports data 310 information about the team gaining nine yards on first down, the gaming engine 330 may be configured to place some weight on the in-stadium users' gaming activity such the gaming engine 330's prediction of the likelihood of that particular betting scenario 340 occurring may be influenced by the in-stadium users' activity.

The amount of weight accorded to the in-stadium users' gaming activity by the gaming engine 330 may depend on numerous factors. For example, the gaming engine 330 may take into account the number of in-stadium users who buy or sell shares of a particular betting scenario 340 before the gaming engine 330 has received updated sports data 310 relating to that particular betting scenario 340. Further, the gaming engine 330 may also take into account the number of shares being bought or sold for a particular betting scenario 340 before the gaming engine 330 has received the updated sports data 310.

Additionally, the gaming engine 330 may take into account the nature of the offered betting scenario 340 and assessing the weight to give to the in-stadium users' gaming activity. For instance, the gaming engine 330 could be configured to consider whether the nature of the offered betting scenario 340 is able to have occurred even though the gaming engine 330 has not received the updated sports data 310. In the example above relating to a baseball player hitting a home run, the gaming engine 330 could consider that it was possible for the player who was batting to have hit a home run or to have been called out or have otherwise made a play that was not a home run, and thereby the gaming engine 330 could assign a particular amount of weight to that betting scenario 340 occurring based on such consideration. On the other hand, if the proposed betting scenario 340 is for a quarterback to throw for 250 yards and, as of the current information, the quarterback only has thrown for 100 yards, the gaming engine 330 would understand that regardless of the previous play, it would not have been possible for the quarterback to reach the 250 yard mark, and therefore, the gaming engine 330 may consider this in assigning a weight to the in-stadium users' gaming activity and adjusting the price accordingly.

In some embodiments, the gaming engine 330 can also generate a price 223 based on users' particular betting activities. For example, the betting engine may determine that a particular user has a tendency to place wagers when the price of a particular betting scenario 340 occurring is set at a certain amount or is set with respect to a certain likelihood of that betting scenario 340 occurring. As such, the betting engine may take this information into account when setting the price that is offered to a particular player.

Referring to FIG. 4, the block diagram illustrates one embodiment of the functioning of the gaming engine 330 as discussed above. Particularly, the gaming engine 330 can receive sports data from third parties 310 and user gaming activity data 320. In some embodiments, the sports data 310 can include, for example, statistical information about the most recent play, a player's current stats, a player currently in the game, a recent injury, a launch angle of a ball, the distance traveled by a ball, or other information about the live sporting event. It will be appreciated that such sports data can be received from a single source or can be aggregated from many different sources. It will be further appreciated that such sports data can include statistics relating to a live sporting event, but can also include statistics from past sporting events as well as information about future sporting events (e.g., the probable starting pitcher for a baseball game, the probable starting lineup for a basketball game, the probable starting tee time for a golfer, and the like).

In some embodiments, the user gaming activity data 320 may be wagers placed on the bettering scenarios by various users or other information that the gaming engine 330 can receive and analyze based on user input.

In one embodiment, the gaming engine 330 may be configured to include or have access to a gaming event format database and/or a betting scenario database which respectively include a number of gaming event formats and betting scenarios. In embodiments, an administrator (i.e., a person) may manually input gaming event formats and/or betting scenario frameworks into the respective database.

For example, the gaming event database may include gaming event formats 350 such as a single game, a single team, a multi-game, a daylong event, a fantasy event, a player props event, a sequential player props event, events that are possession-by-possession, hole-by-hole, time-limited, inning-by-inning, and other sports gaming event formats.

The gaming engine 330 may be configured to select one or more of such gaming event formats from the gaming event format database and to offer one or more of the gaming event formats to users. In one embodiment, the gaming event formats may be offered to users via a graphical interface of an application and in a further embodiment, the gaming events may be broken down into categories, such as by sport, by type (e.g., fantasy, single, wagering opportunities, and the like), and by league, among others.

Further, in one embodiment, the gaming engine 330 may be configured to offer only the most popular gaming event formats for each sport. For example, even though the gaming event format database may include more than one hundred baseball gaming event formats, the gaming engine may be configured to offer only a subset of all of the gaming event formats, for example, the three most popular baseball gaming event formats. Accordingly, a user may then be able to select one or more gaming events in which to participate based on those offered by the gaming engine.

Further, in one embodiment, the betting scenario database may be configured to include a number of betting scenarios, such as “Player X will score Y number of points in Z time period,” “Team A will score B number of goals in C time period,” “Pitcher D will throw E number of pitches in F period of a baseball game.” It will be appreciated that there are a countless number of betting scenarios that could be stored in the betting scenario database and which could be offered to users by the gaming engine 330, but that the betting engine could be configured to determine the more popular betting scenarios based on, for example, how many wagers have historically been placed on each scenario or how much value has historically been wagered on each scenario.

In one embodiment, the gaming engine 330 may be configured to offer only the most popular betting scenarios, wherein the betting scenarios may be categorized such as by sport, by gaming event format, by player, or the like. As such, based on, for example, the thousands of betting scenarios that could be stored in the betting scenario database relating to a basketball game, the gaming engine 330 may be configured to offer betting scenarios relating to only the three top scoring players on each team, and more specifically, the gaming engine may be configured to offer betting scenarios only relating to each of such top three scorers scoring at least a certain number of points in a certain amount of time. Accordingly, a user may then be able to select one or more betting scenarios in which to participate based on those offered by the gaming engine 330.

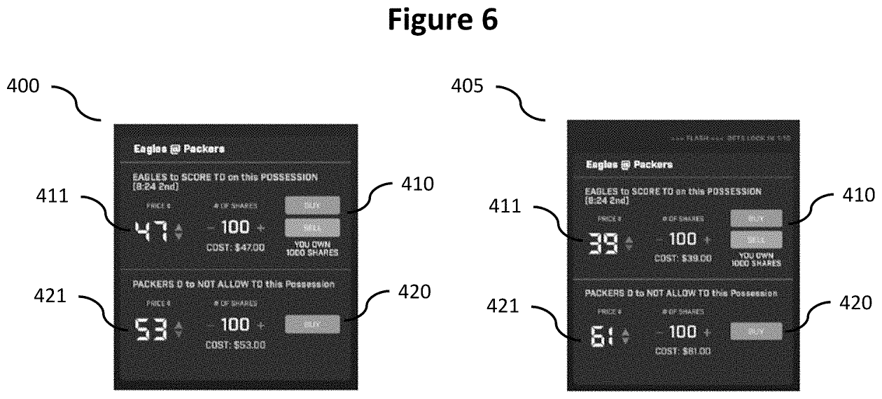

FIG. 6 illustrates a second interface for displaying sports wagering using dynamic real-time pricing and trading according to an embodiment of the present disclosure.

Referring to FIG. 6, the gaming engine can generate double-sided betting scenarios, in other words, betting scenarios that are essentially the opposite results of each other. Interface 400 can show the dual-sided bets at time, T1, and interface 405 can show the dual-sided bets at time, T2. In one embodiment, the double-sided betting scenarios can be displayed on bet selection interfaces 410 and 420 within the application interfaces 400 and 405. Both bet selection interfaces 410 and 420 may display information similar to the information displayed on the bet selection interface 223 disclosed in FIG. 2. In one embodiment, the bet selection interface 410 may display one side of a betting scenario while the bet selection interface 420 may display the other side of the betting scenario.

By way of example, bet selection interface 410 can display a betting scenario from a game between the Philadelphia Eagles and the Green Bay Packers wherein the Eagles are on offense, while the Packers are on defense. The bet selection interface 410 can display a betting scenario generated by the betting engine or otherwise on whether the Eagles will score a touchdown on their current possession. The bet selection interface 410 may also include a price 411 generated by the betting engine or otherwise based on the probability that the Eagles will score a touchdown on that current possession. Additionally, the bet selection interface 420 may display a betting scenario on whether the Packers will prevent the Eagles from scoring a touchdown on the Eagles' current possession. The bet selection interface 420 may also include a price 421 generated by the betting engine or otherwise based on the probability that the Packers will prevent the Eagles from scoring a touchdown on the Eagles' current possession. The prices 411 and 421 may fluctuate based on changes in the sporting event and changes in the probabilities. For example the price 411 may change from 47 at time, T1, to 39 at time T2, and the price 421 may change from 53 at time, T1, to 61 at time T2.

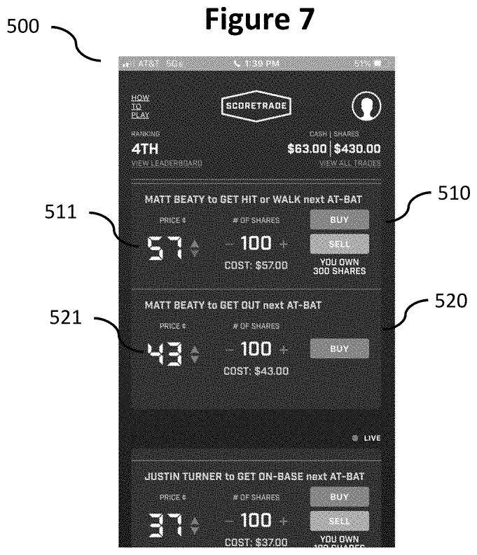

FIG. 7 illustrates a third interface for displaying sports wagering using dynamic real-time pricing and trading according to an embodiment of the present disclosure.

Referring to FIG. 7, the gaming engine can generate multi-sided betting scenarios, in other words, betting scenarios that are related to each other upon certain events occurring. The multi-sided betting scenarios can be displayed on bet selection interface 510 and 520 within the application interface 500. Bet selection interfaces 510 and 520 may display information similar to the information displayed on the bet selection interface 223 disclosed in FIG. 2. The bet selection interfaces 510 and 520 may display multiple sides of a bet. By way of example, bet selection interfaces 510 and 520 may display betting scenarios based on a baseball player's current at bat. The bet selection interface 510 can display a betting scenario that the batter will get a hit or walk in his current at bat. The bet selection interface 510 can also display a price 511 based on the probability that the batter will get a hit or a walk in his current at bat. The bet selection interface 520 can display a betting scenario that the batter will get out in his current at bat. The bet selection interface 520 can also display a price 521 based on the probability that the batter will get a hit or a walk in his current at bat. The prices 511 and 521 may fluctuate based on occurrences in the sporting event and changes in the probabilities. According to this example, only one of the two options can be worth 100 at the end of the player's at bat. The other option may be worth 0.

In another example, the application interface 500 can display multi-sided betting scenarios of varying sizes. By way of example, the application interface 500 may display several betting scenarios based on the Philadelphia Eagles current offensive possession. One betting scenario may be that the Eagles quarterback (QB) will score a touchdown on the current possession, and have a price based on the probability that the QB will score a touchdown on the current possession. A second betting scenario may be a bet that an Eagles wide receiver (WR) will score a touchdown on the current possession, and have a price based on the probability that a particular Eagles WR will score a touchdown on the current possession or also that any Eagles WR will score a touchdown on that possession. A third betting scenario may be a bet that a particular Eagles running back (RB) will score a touchdown on the current possession, and have a price 531 based on the probability that a particular Eagles RB will score a touchdown on the current possession or also that any Eagles RB will score a touchdown on that possession. A fourth betting scenario may be that no Eagles players will score a touchdown on the current possession, and have a price based on the probability that no Eagles players will score a touchdown on the current possession.

In some embodiments, the sum of the prices of the betting scenarios within the multi-sided bet may not equal 100. In other embodiments, the sum of the prices of the betting scenarios within the multi-sided bet may exceed 100. According to various embodiments, each of the prices of the betting scenarios within the multi-sided bet can change independent from the other prices.

In some embodiments, the gaming engine may update a price faster for one bet than the price than another bet. This may be due to the need for a gaming operator (e.g., a human overseeing the operation of a gaming event) to have their profit margin embedded into the prices of the bets where the collective bets are priced to equal more than 100. The total sum of the bet prices may exceed 100 and the goal may be the only pay out 100 to maintain a substantial profit margin. Other reasons may include creating intentional arbitrage opportunities or discounted opportunities to make the game more entertaining by creating more winners.

In some embodiments, the gaming engine can generate betting scenarios for real-time in-game fantasy sports tournaments and leagues. The generated betting scenarios may include bets that a particular player will reach a particular achievement (e.g., a fantasy target). Additionally, the gaming engine can generate a price for the betting scenarios based on the probability that the betting scenario will occur. For example, the generated betting scenario may be that a quarterback will throw for more than 300 yards in his game today or that a running back will score three touchdowns in his game today. According to this embodiment, the user can build a portfolio or a team by selecting a number of these betting scenarios. The user can choose to buy a number of shares that a particular player will reach his fantasy target. Based on the user's strategy, the user can allocate a larger portion of his available tournament funds to the particular player. Over the course of the fantasy sports tournament or league, the user may accumulate points if the wagers become successful. The number of points can be equal to the price of the successful bet. By way of example, if a user places a wager that a quarterback will throw for more than 300 yards in his game today at a price of 60 and the betting scenario occurs, then the user can earn 60 points. Further, a user can sell wagers over the course of the fantasy sports tournament or league. For example, a user may own a wager that a quarterback will throw for more than 300 yards in his game today at a price of 60. Based on the play of the quarterback, the probability that the betting scenario will occur can change. For example, if the quarterback is performing well, the price of the wager may increase to 80. The user can then sell the bet and earn 20 points, the profit from the sale. According to this embodiment, the player that accumulates the most points can be the winner of the tournament.

In one example, a fantasy basketball tournament can have a $1 entry fee and a $100 first place prize. Upon entry into the contest, the user may get a fake $500 budget to assemble a fantasy roster in the form of a portfolio. The potential options for building a fantasy roster may include:

LeBron James to SCORE 25+ points this Game at a price of 45;

Russell Westbrook to SCORE 18+ Points this Game at a price of 36;

Giannis to SCORE 32 Points this Game at a price of 55; or

James Harden to SCORE 36 Points this Game at a price of 32.

In each case as illustrated above, the gaming engine 330 may be configured to take into account numerous factors as discussed herein to determine the initial price. Further, the gaming engine may be configured to continuously evaluate the same factors as well as additional factors once the game starts and thus continuously adjust the price as the game progresses. The objective, for example, may be to take the $500 budget in tournament dollars to buy shares in the fantasy targets that the user sees as their best chance of accumulating the most tournament dollars (e.g., tournament points).

According to this example, the price can be the probability of the player achieving the fantasy target. If the player achieves the fantasy target, the shares will be worth 100. If the player does not, the shares will be worth 0. For instance, if LeBron James scores 30 points during the game, the shares will be worth 100 since the probability of him scoring more than 25 points is 100%. The gaming user, as the game is progressing, may elect to sell shares before the event is over. For instance, if LeBron James has 20 points in the first quarter, the shares might have a price of 90 reflecting the gaming engine's determination that there is a 90% probability of LeBron scoring more than 25 points this game because 3 full quarters are left. As such, a user may be able to see their shares and then buy shares of others players if they want in order to try to win the fantasy tournament.

According to this embodiment, the price can be determined by an algorithm, human input, weighing supply and demand, or a combination taking into account time remaining in the game to achieve the fantasy target, the game situation, whether the player is in the game, injury status, shooting percentage, likelihood of getting fouled out, need for the team to shoot 3 pointers based on how far ahead or behind they are, the level of player involvement in the game, or other factors.

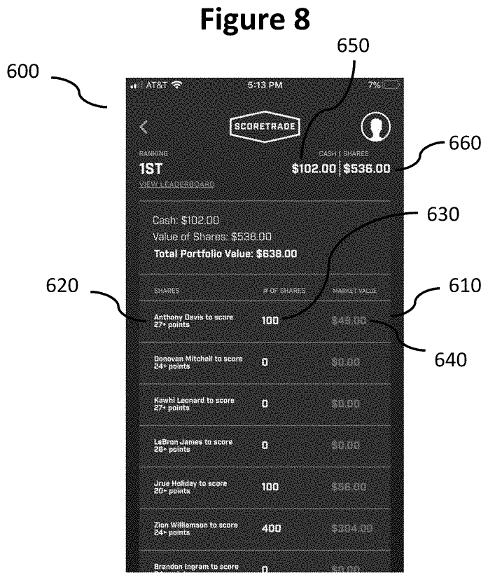

FIG. 8 illustrates an interface for displaying real-time in-game fantasy sports tournaments and leagues using dynamic real-time pricing and trading according to an embodiment of the present disclosure.

Referring to FIG. 8, an application interface 600 can show a list of betting scenarios 610 that can be used to build a roster or portfolio for a real-time in-game fantasy sports tournaments and leagues. The betting scenario 610 can include a fantasy target 620, the number of shares 630 of the betting scenario, and the market value 640 (e.g., price) of the betting scenario. The application interface 600 can also display the user's current portfolio budget 650 and total number of portfolio shares 660 owned by the user.

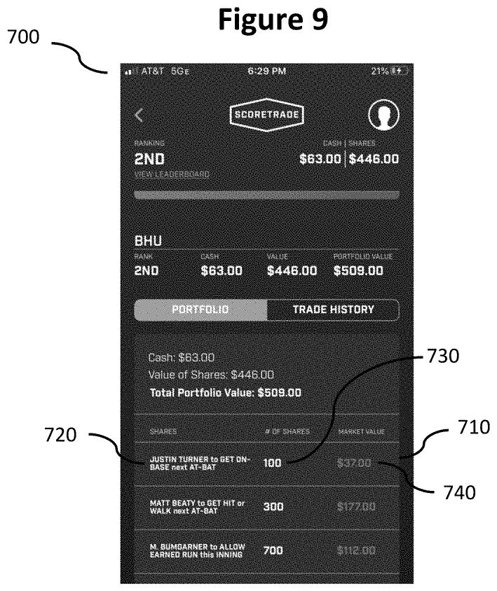

FIG. 9 illustrates an interface for a portfolio in a real-time in-game fantasy sports tournaments and leagues using dynamic real-time pricing and trading according to an embodiment of the present disclosure.

Referring to FIG. 9, an application interface 700 can show a list of betting scenarios 710 that are currently in the user's roster or portfolio for a real-time in-game fantasy sports tournaments and leagues. The betting scenario 710 can include a fantasy target 720, the number of shares 730 of the betting scenario, and the market value 740 (e.g., price) of the betting scenario.

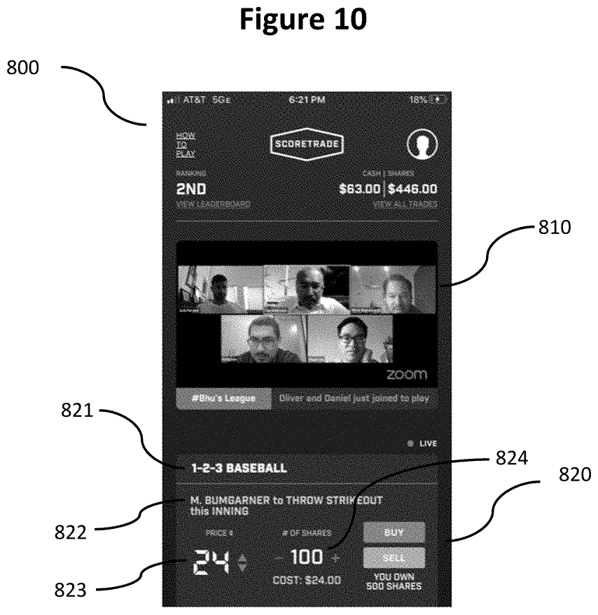

FIG. 10 illustrates an interface of a real-time in-game fantasy sports tournaments and leagues using dynamic real-time pricing that displays a community call according to an embodiment of the present disclosure.

Referring to FIG. 10, the application interface 800 can incorporate a video stream 810 adjacent to a bet selection interface 820. According to this embodiment, video stream 810 may display a collage of videos of one or more of the users in the community call. The users on the call can communicate with each other about current sporting events and bets placed by the players on the community call.

In one embodiment, the gaming engine can generate betting scenarios based on the conversation with the users. For example, the users may be arguing about whether a basketball player will continue his accurate shooting and the gaming engine can generate a betting scenario on whether the basketball player will score 50 points. The generated betting scenario can be displayed on the bet selection interface 820 of each of the guests.

The bet selection interface 820 may include certain information relating to the displayed betting scenario including the title of a sporting event 821, a bet description 822, the price of a single bet share 823, and the total number of shares 824. The information displayed on the bet selection interface 820 can be updated in real time by the gaming engine. The gaming engine may track bets placed by the players in the device application.

In some embodiments, the gaming engine may update the price 823 in response to recent events in a live sporting event or in response to bettors placing bets within the device application. For example, the gaming engine may generate a bet on whether a basketball team to win a current game. As the game progresses to its conclusion, the team may be increasing its lead. This may lead to the probability of whether the team will win the game. As such, the gaming engine can adjust the price 823 based on the changing probability of whether the bet will be successful.

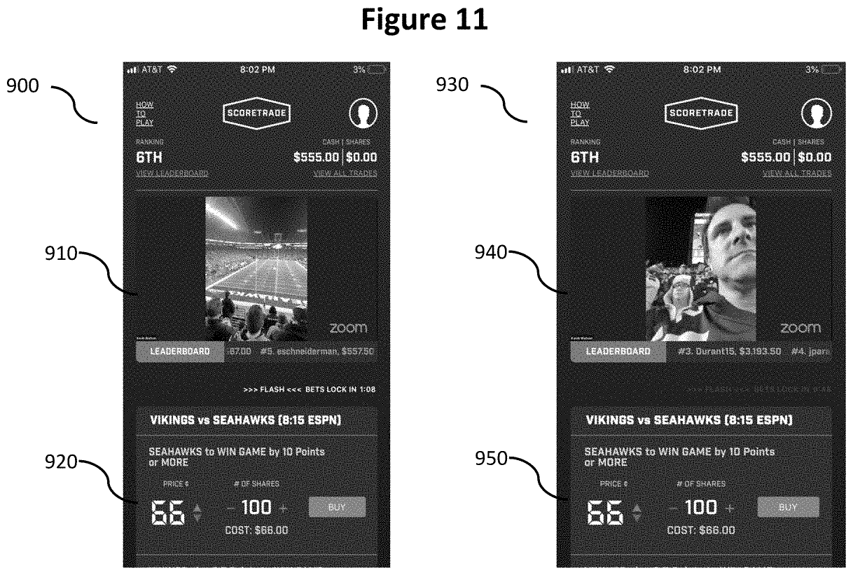

FIG. 11 illustrates an interface of a real-time in-game fantasy sports tournaments and leagues using dynamic real-time pricing that displays a user video stream according to an embodiment of the present disclosure.

Referring to FIG. 11, the application interfaces 900 and 930 can incorporate video streams 910 and 940 adjacent to bet selection interfaces 920 and 950. According to this embodiment, video streams 910 and 940 may display a video stream broadcast from a user's device. In some embodiments, the user can use a third party service provider (e.g., Zoom) to transmit the user's video stream to other users.

In one embodiment, the gaming engine can generate betting scenarios based on the content of the video streams 910 and 940. For example, the user broadcasting his video stream may be discussing a running back's current performance in a live football game. The gaming engine may generate a betting scenario on whether the running back will reach 100 yards rushing by the end of the first half. The generated betting scenario can be displayed on the bet selection interfaces 920 and 950.

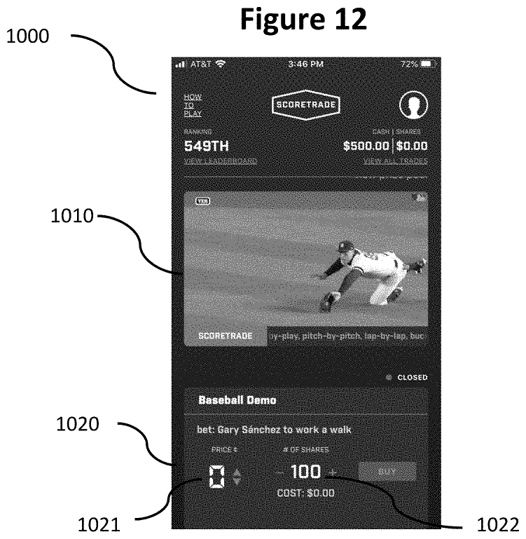

FIG. 12 illustrates an interface of a real-time in-game fantasy sports tournaments and leagues using dynamic real-time pricing that displays a live sporting event according to another embodiment of the present disclosure.

Referring to FIG. 12, the application interface 1000 can incorporate a video stream 1010 adjacent to or as otherwise a part of a bet selection interface 1020. According to this embodiment, video stream 1010 may display a live video broadcast feed from a sporting event. In some embodiments, the bet selection interface 1020 can display betting scenarios based on the sporting event being shown on the video stream 1010. For example, the video stream 1010 may show a baseball game and the bet selection interface 1020 can display a proposed bet on whether the pitcher will strike out the next batter. Further, the betting engine may be capable of transcribing audio of the video stream 1010 or accessing the closed caption text of the video stream and based on such information, the betting engine may be able to automatically generate betting scenarios to be offered to users of the application.

The bet selection interface 1020 may include information about various betting scenarios, including among other things, the price of a single share of the bet 1021, and the total number of shares 1022. The information displayed on the bet selection interface 1020 can be updated in real time by the gaming engine.

In order to view a live sporting event on the video stream 1010, the user may be required to have a television provider subscription, such as a cable television subscription or a satellite television subscription. Many common television subscription services provide a username and password to subscribers. The application interface 1000 can allow users to authenticate their subscriptions by allowing them to enter the username and passwords corresponding to their television subscription. The application can verify the username and password information with the corresponding subscription provider. If verification is successful, the application can retrieve the broadcast feed of the live sporting event and display it on the video stream 1010. In one embodiment, with the video stream of the sporting event embedded into the application, the gaming engine can generate betting scenarios based on the sporting event displayed on the video stream. In another embodiment, the user can switch to watch a different live sporting event from the authenticated pay television provider on the video stream 1010. The gaming engine can generate new betting scenarios based on the different live sporting event that is now displayed on the video stream 1010.

According to some embodiments, the gaming engine can incorporate sports wagering activity from various jurisdictions (e.g., U.S. states) to calculate a price. For example, the gaming engine can assess the level of demand for a betting scenario, such as Tom Brady to throw for 300 yards, from across multiple jurisdictions, and use this data to more accurately price this bet in an intra-jurisdictional environment.

In one embodiment, a user can build a portfolio or a team by selecting a player to reach a fantasy target at each position on a traditional sports team roster. The user can select the number of shares for each player that the player will reach his fantasy target. The user, in another variation, may select as few as two players on a team. As the games are progressing, the prices of the betting scenarios change as calculated by the gaming engine taking into account sports data and historical data and predicting the likelihood of each betting scenario occurring and the user can buy or sell shares, constantly adjusting his portfolio to maximize the portfolio. The price can be the probability of the player scoring the most fantasy points compared to the other players listed at the same position. For example, the user may be provided the following betting scenarios below which, in this case, display the objective, the player's name, and the initial price which is calculated by the gaming engine based on taking into account the sports data and historical data as described herein and by comparing the applicable data of the players offered against each other:

Which QB listed below will score most fantasy points today:

Drew Brees—50

Tom Brady—25

Aaron Rodgers—25

Which RB listed to score most fantasy points today:

Christian McCaffrey—23

Saquon Barkley—66

Ezekiel Elliott—11

WR to SCORE most Fantasy Points today:

Michael Thomas—24

Davante Adams—26

Tyreek Hill—50

TE to SCORE most fantasy points today:

Travis Kelce—35

Zach Ertz—35

George Kittle—30

K to SCORE most fantasy points today:

Justin Tucker—32

Harrison Butker—33

Wil Lutz—45

D/Special Teams to SCORE most fantasy points today:

San Francisco—60

Baltimore—20

Pittsburgh—20

In another embodiment, the gaming engine can generate betting scenarios for a fantasy basketball tournament and priced in real-time in a manner compliant with local fantasy gaming regulations. The betting scenarios may include a fantasy target and a list of basketball players. The fantasy targets may include, but are not limited to the first player to score 10 points, the first to rebound, or the first player to get 10 assists. The user can select two or more players from the list that the user believes will achieve the fantasy target. The user can select the players by buying shares using the tournament dollars. For example, the betting scenario may be:

First 5 players to SCORE in Tonight's Game:

Player 1

Player 2

Player 3

Player 4

. . .

Player 23

Player 24

Each of the players listed may be displayed with a price as calculated by the gaming engine reflecting the gaming engine's prediction of the probability that the player will be among the first five players to score in the game. As each player becomes one of the first five players to score in the game, his price will be worth 100. The prices of the players that were not one of the first five players to score will become 0. As will be appreciated, countless other betting scenarios along the lines of the example above could also be generated with the gaming engine predicting the probabilities for each player in each scenario.

In another embodiment, the gaming engine can generate a sequential fantasy game created for a half-inning of baseball. According to this embodiment, the gaming engine may generate a list of potential outcomes of the current batter. For example, the outcomes may include: the batter to hit a single, the batter to strike out, the batter to get an extra base hit, the batter to ground out, or the batter to walk. Using the tournament dollars, the user can choose to buy shares in the outcome of the batter. In some embodiments, the engine can also generate a list of potential outcomes of the pitcher in the current at bat. The system can also validate that the user has some shares in players on both teams, both the pitcher and batters, as most states do not consider a fantasy game to simply involve selections on one team's roster. The same type of sequence of batters and pitchers may be repeated for the other half of the inning or any number of innings.

In another embodiment, the gaming engine can generate betting scenarios where one sports player's individual achievements are compared against another sports player's individual achievements in their respective current sports games (i.e., a head-to-head matchup). The two sports players may or may not be playing in the same sports game. The user can select the number of shares for the sports player that the user believe will have greater individual achievements in his game. If the selected sports player has greater individual achievements in his game than the other sports player in his game, then the selected sports player's price will be 100. As the games are progressing, the probability and price of each of the sports players can change as the gaming engine continuously reevaluates the probability of each betting scenario occurring to reflect the real-world performance and the likelihood of each player outscoring or out achieving the other player in his head-to-head matchup. The user can trade in and out shares to accumulate the most tournament dollars. This head-to-head matchup format can be used for any sport and a variety of fantasy targets. Examples of betting scenarios according to this embodiment, may include:

LeBron to SCORE more than Kawhi Leonard—55;

Kawhi to SCORE more than LeBron—45;

Russell Westbrook to SCORE more than Chris Paul—32;

Chris Paul to SCORE more than Russell Westbrook—68;

Steph Curry to HIT more 3-pointers than James Harden—66; or

James Harden to HIT more 3-pointers than Steph Curry—34.

In some embodiments, the fantasy targets may be full game targets or in-game targets. Examples of in-game targets may include:

Steph Curry to HIT 2 3-pointers in the First Quarter at a price of 45;

LeBron James to SCORE 5 points in the First Quarter at a price of 40; or

Russell Westbrook to have 3 ASSISTS by 6:00 mark of 2nd quarter at a price of 65.

In one embodiment, a fantasy tournament may incorporate auto racing. In one example, the gaming engine 330 may be configured to offer a user the ability to select a driver to be in the top 5 by Lap 50. For example, Kyle Busch to be in Top 3 at end of Lap 50 could be priced at 50 by the gaming engine and Chase Elliot to be in Top 3 at end of Lap 50 could be priced at 10 by the gaming engine. As will be appreciated, the gamine engine 330 could offer each driver at a price, which could fluctuate during the race, taking into account distance between drivers, current position, pit-stops, and other factors.

In another embodiment, a fantasy tournament can be run for a single hole of a golf tournament across multiple players. The gaming engine 330 can determine which golfers are playing which hole or which players may be playing a particular hole based on the sports data received. According to this embodiment, the following fantasy betting scenarios could be generated by the betting engine:

Tiger Woods to shoot PAR or BETTER on hole 12 at a price of 75;

Brooks Koepka to shoot PAR or Better on hole 11 at a price of 60;

Phil Mickelson to shoot BIRDIE or BETTER on hole 11; or

Jason Day to shoot PAR or BETTER on hole 10.

Further, the gaming engine could determine that the fantasy tournament is likely to end in 20 minutes as the golfers will be simultaneously playing their final holes. In another embodiment, the fantasy betting scenarios could be offered sequentially. For example, if Tiger Woods achieves a par or better on hole 12, then the gaming engine could generate betting scenarios for Tiger Woods on hole 13.

In some embodiments, the gaming engine can use the location of a user to determine what fantasy tournaments comply with local sports gaming regulations. For example, some U.S. states may have regulations that can allow for partial game fantasy contests, whereas other states may only allow fantasy games to be based on the full game results of a real world player in a real world sporting event. For instance, a fantasy target on Tom Brady to PASS for 75 yards in the first quarter may be allowed in one state whereas in another state, only a full game target of Tom Brady to pass for 275 yards for the game may be allowed. Accordingly, the gaming engine 330 could be configured to only offer the partial game betting scenario in certain states and the full game betting scenario in other states.

Further, some U.S. states have legalized sports betting, and most U.S. states do not consider fantasy gaming tournaments to be sports wagering. Additionally, due to the U.S. Wire Act, transmitting sports wagering information across U.S. state lines is a federal offense. In one embodiment, the gaming engine can use data and inputs from fantasy tournaments to price in-game bets in U.S. states where sports betting is legal and transmit this data to the U.S. states where sports betting is legal as fantasy sports data. This can allow the gaming engine to run fantasy sports tournaments across multiple U.S. states. Using this fantasy sports wagering data, real money sports bets intrastate can be priced in real-time using inputs from users' reactions across U.S. state lines without violating the Wire Act.

In some embodiments, the gaming engine can generate betting scenarios for in-game sports betting tournaments. According to this embodiment, the gaming engine can generate bets based on the final outcome of live sporting events or based on team-oriented bets. For example, a tournament can be based on a March Madness Bracket tournament and the prices of the generated bets can be updated in real-time throughout each game.

In some embodiments the gaming engine can generate betting scenarios for simple cash wagers. For example, the gaming engine can generate a bet that a quarterback will throw for more than 300 yards in his game today. The user can place a wager against another user in a peer-to-peer gaming event or against the house.

In some embodiments, the artificial intelligence of the gaming engine can be trained to be able to more accurately determine probabilities of certain events occurring and thus to be able more accurately price betting scenarios. For example, the gaming engine could be configured to evaluate how often users place a wager on either side of a two-sided bet based on particular prices set for that betting scenario and to thereafter adjust the price of future similar betting scenarios based on the past human behavior of either side of the betting scenario being chosen based on a particular price.

In some embodiments, the probabilities of players achieving fantasy targets generated by the gaming engine can be exported to other gaming formats offered by third party operators. For example, third party operators can use the gaming engine's 0-100 prices as a factor in generating their own pricing formats.

In some embodiments, the gaming engine's pricing and probabilities can be used in electronic sports (e-sports), including, but not limited to, console video games and mobile device video games. Additionally, the data from the gaming engine can be distributed to gaming operators who want to price live bets via a live data feed.

It will be understood that when an element is referred to as being “on,” “connected to,” or “coupled to” another element, it may be connected, or coupled to the other element or one or more intervening elements may also be present. When an element is referred to as being “directly connected to,” or “directly coupled to” another element, there are no intervening elements or layers present. For example, when a first element is described as being “coupled” or “connected” to a second element, the first element may be directly coupled or connected to the second element or the first element may be indirectly coupled or connected to the second element via one or more intervening elements.

The same reference numerals designate the same elements. As used herein, the term “and/or” includes any and all combinations of one or more of the associated listed items. Further, the use of “may” when describing embodiments of the present invention relates to “one or more embodiments of the present invention.” Expressions, such as “at least one of,” when preceding a list of elements, modify the entire list of elements and do not modify the individual elements of the list. Also, the term “exemplary” is intended to refer to an example or illustration. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments. In the figures, dimensions of the various elements, layers, etc. may be exaggerated for clarity of illustration.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing particular example embodiments of the present invention and is not intended to be limiting of the described example embodiments of the present invention. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a) and 35 U.S.C. § 132(a).

The term “processing circuit” is used herein to mean any combination of hardware, firmware, and software, employed to process data or digital signals. Processing circuit hardware may include, for example, radio baseband processors (BPs or BBPs), application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Various computational portions of embodiments of the present invention, including the operation of a sports gaming event through a computing device application, may be implemented through purpose-specific computer instructions executed by a computer system. The computer system may include one or more processors, including one or more central processing units (CPUs), one or more graphics processing units

(GPUs), one or more field programmable gate arrays (FPGAs), one or more digital signal processors (DSPs), and/or one or more application specific integrated circuits (ASICs). The computer system may also include peripherals such as communications devices (e.g., network adapters, serial or parallel data bus adapters, graphics adapters) for transmitting and/or receiving data to and from other devices such as data storage systems (e.g., databases), display devices, and other computer systems. The computations may be distributed across multiple separate computer systems, some of which may be local to the users (e.g., user devices such as smartphones and personal computers) and some of which may be remote (e.g., off-site, “cloud” based computing resources connected to the user devices through a wide area network such as the Internet).

Although example embodiments of the system and method for sports wagering using a user's location and their participation in a gaming event to predict the probability of a betting scenario occurring and thereby influencing dynamic real-time pricing and trading have been described and illustrated herein, many modifications and variations within those embodiments will be apparent to those skilled in the art. Accordingly, it is to be understood that the system and method for sports wagering using a user's location and their participation in a gaming event to predict the probability of a betting scenario occurring and thereby influencing dynamic real-time pricing and trading according to the present invention may be embodied in forms other than as described herein without departing from the spirit and scope of the present invention. The present invention is defined by the following claims and equivalents thereof.

What is claimed is:

1. A system for operating a sports gaming event using a graphical interface of a computing device application, the system comprising:
a processor; and
a memory coupled to the processor, wherein the memory stores instructions that, when executed by the processor, cause the processor to:
select at least one betting scenario from a betting scenario database;
determine a location of the at least one betting scenario;
calculate an initial probability of the at least one betting scenario occurring based on sports data and historical statistics;
generate an initial price of the at least one betting scenario based on the initial probability;
display the betting scenario and the initial price on the graphical interface;
receive a response to the at least one betting scenario from at least one user;
determine a location of the at least one user;
compare the location of the at least one user to the location of at least one betting scenario;
calculate, based on the response to the betting scenario from the at least one user and based on determining the location of the at least one user to be proximate to the location of the at least one betting scenario, whether the initial probability of the betting scenario occurring has changed;
generate an updated price if the initial probability has changed; and
display the updated price on the graphical interface.

2. The system according to claim 1, wherein the instructions further cause the processor to:
receive updated sports data via a network;
calculate an updated probability of the betting scenario being successful based on the updated sports data;
generate a further updated price of the at least one betting scenario if the updated probability has changed; and
display the further updated price on the graphical interface.

3. The system according to claim 1, wherein the processor is configured to receive responses to the at least one betting scenario from a plurality of users and to determine the locations of each of the plurality of users,
wherein, to calculate whether the initial probability of the betting scenario occurring has changed, the processor may be configured to place greater weight on a response from any user located proximate to the at least one betting scenario than a response from any user that is not located proximate to the at least one betting scenario .

4. The system according to claim 1, wherein the processor is configured to access a seating map area of the location of the at least one betting scenario and wherein the processor is configured to determine whether the location of the at least one user is within the seating map area.

5. The system according to claim 4, wherein, when the location of the at least one user is within the seating map area, the processor is configured to evaluate whether the location of the at least one user provides reliable viewing access to an outcome of the at least one betting scenario.

6. The system according to claim 1, wherein the response to the at least one betting scenario from at least one user comprises:
buying at least one share of the at least one betting scenario; or
selling at least one share of the at least one betting scenario.

7. The system according to claim 6, wherein, when the location of the at least one user is determined to be proximate to the location of the at least one betting scenario and the response from the at least one user is to buy at least one share of the at least one betting scenario, the instructions cause the processor to increase the initial probability of the at least one betting scenario occurring.

8. The system according to claim 6, wherein, when the location of the at least one user is determined to be proximate to the location of the at least one betting scenario and the response from the at least one user is to sell at least one share of the at least one betting scenario, the instructions cause the processor to decrease the initial probability of the at least one betting scenario occurring.

9. The system according to claim 1, wherein, when the location of the at least one user is determined to be proximate to the location of the at least one betting scenario, the processor is configured to predict, based on the response from the at least one user, that the at least one betting scenario has occurred, the instructions cause the processor to remove the at least one betting scenario from the graphical interface.

10. A method for operating a sports gaming event using a graphical interface of a computing device application, the method comprising:
receiving, by a processor, sports data via a network;
generating, by the processor, a betting scenario based on the sports data;
determining a location of the at least one betting scenario;
calculating, by the processor, an initial probability of the betting scenario occurring based on the sports data;
generating, by the processor, an initial price of the betting scenario based on the initial probability, wherein the initial price comprises a number between 1 and 99;
displaying, by the processor, the betting scenario and the initial price on the graphical interface;
receiving, by the processor, a response to the betting scenario from at least one user;
determining, by the processor, a location of the at least one user;
comparing, by the processor, the location of the at least one user to the location of the at least one betting scenario;
calculating, by the processor, based on the response to the betting scenario from the at least one user and based on determining the location of the at least one user to be proximate to the location of the at least one betting scenario, whether the initial probability of the betting scenario occurring has changed;
generating, by the processor, an updated price if the initial probability has changed; and
displaying, by the processor, the updated price on the graphical interface.

11. The method according to claim 10, the method further comprising:
receiving, by the processor, updated sports data via a network;
calculating, by the processor, an updated probability of the betting scenario being successful based on the updated sports data;
generating, by the processor, a further updated price of the at least one betting scenario if the updated probability has changed; and
displaying, by the processor, the further updated price on the graphical interface.

12. The method according to claim 10, wherein the processor is configured to receive responses to the at least one betting scenario from a plurality of users and to determine the locations of each of the plurality of users and
wherein, in calculating whether the initial probability of the betting scenario occurring has changed, the processor places greater weight on a response from any user located proximate to the at least one betting scenario than a response from any user that is not located proximate to the at least one betting scenario .

13. The method according to claim 10, further comprising accessing, by the processor, a seating map area of the location of the at least one betting scenario and determining, by the processor, whether the location of the at least one user is within the seating map area.

14. The method according to claim 13, wherein, when the location of the at least one user is determined to be within the seating map area, evaluating, by the processor, whether the location of the at least one user provides reliable viewing access to an outcome of the at least one betting scenario.

15. The method according to claim 10, wherein the response to the at least one betting scenario from at least one user comprises:
buying at least one share of the at least one betting scenario; or
selling at least one share of the at least one betting scenario.

16. The method according to claim 15, wherein, when the location of the at least one user is determined to be proximate to the location of the at least one betting scenario and the response from the at least one user is to buy at least one share of the at least one betting scenario, calculating, by the processor, an increase in the initial probability of the at least one betting scenario occurring.

17. The method according to claim 15, wherein, when the location of the at least one user is determined to be proximate to the location of the at least one betting scenario and the response from the at least one user is to sell at least one share of the at least one betting scenario, calculating, by the processor, a decrease in the initial probability of the at least one betting scenario occurring.

18. The method according to claim 10, wherein, when the location of the at least one user is determined to be proximate to the location of the at least one betting scenario, predicting, by the processor, based on the response from the at least one user, that the at least one betting scenario has occurred, and removing, by the processor, the at least one betting scenario from the graphical interface.

19. The method according to claim 10, wherein determining a location of the at least one user comprises accessing, by the processor, a user's mobile device's geo-location data.

20. The method according to claim 10, wherein calculating whether the initial probability of the betting scenario occurring has changed further comprises comparing, by the processor, a response received from a first user determined to be proximate to the betting scenario against a response received from a first user determined to not be proximate to the betting scenario.
